(19) United States
(12) Patent Application Publication
(10) Pub. No.: US 2026/0289435 A1
(43) Pub. Date: Sep. 24, 2026

(54) SYSTEM

(71) Applicant: SoftBank Group Corp., Tokyo (JP)

(72) Inventor: Miho AYABE, Tokyo (JP)

(73) Assignee: SoftBank Group Corp., Tokyo (JP)

(21) Appl. No.: 19/567,475

(22) Filed: Mar. 16, 2026

(30) Foreign Application Priority Data
Mar. 19, 2025 (JP) 2025-045034

(51) Int. Cl. G06Q 10/02; G06N 3/0475

(52) U.S. Cl. CPC G06Q 10/025; G06N 3/0475

(57) ABSTRACT

A system includes a processor that is configured to receive input information from a user, analyze the received input information and generate, based on a result of the analysis, a prompt for instructing generation of a travel plan, and input the generated prompt to a generative artificial intelligence model to cause the generative artificial intelligence model to generate the travel plan.

### CROSS-REFERENCE TO RELATED APPLICATION

This application is based on and claims priority under 35 USC 119 from Japanese Patent Application No. 2025-045034 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems require the user to manually search for destinations, accommodations, restaurants, and activities, and to assemble a travel plan by themselves based on scattered information. Even when some level of recommendation is provided, such systems typically rely on fixed rule-based engines or limited filtering functions, and therefore cannot flexibly reflect complex and diverse user conditions such as budget, physical strength, and points emphasized by the user. As a result, the user must repeatedly adjust search conditions and manually compare multiple options, which imposes a significant time and cognitive burden. In addition, existing systems are not well adapted to utilizing generative artificial intelligence models in a structured manner: inputs to such models are often ad hoc and unstructured, making it difficult to obtain stable, reproducible, and user-tailored travel plans. Accordingly, there is a need for a system that can systematically acquire input information from the user, analyze the acquired information, generate a suitable prompt that instructs generation of a travel plan, and cooperate with a generative artificial intelligence model so that a customized travel plan can be automatically generated in accordance with individual user conditions.

### SUMMARY

In order to solve the above-described problems, according to one aspect of the present invention, there is provided a system comprising a processor, wherein the processor is configured to receive input information from a user, analyze the received input information, and generate, based on a result of the analysis, a prompt for instructing generation of a travel plan, and to input the generated prompt to a generative artificial intelligence model so as to cause the generative artificial intelligence model to generate the travel plan. In one embodiment, the processor is configured to take into account a budget of the user, a physical strength of the user, and points emphasized by the user, and to generate the prompt including elements representing the budget, the physical strength, and the points emphasized by the user, whereby the generative artificial intelligence model is guided to output a travel plan that is appropriately customized to the user's economic and physical conditions and to the user's preferences. In another embodiment, the processor is configured to collect the input information from the user through a form on a website or an application, and to convert the collected information into structured data by using an analysis unit, thereby enabling consistent analysis of user inputs and systematic construction of the prompt. By these means, the system can automatically obtain, in cooperation with the generative artificial intelligence model, a travel plan that reflects the individual user's constraints and preferences, while reducing the burden on the user in creating and adjusting the travel plan.

The term “system” refers to a combination of hardware and software components, including at least one processor and associated memory, input/output interfaces, and communication functions, that cooperatively perform the functions described in the claims.

The term “processor” refers to one or more hardware processing units, such as a central processing unit (CPU), a graphics processing unit (GPU), a digital signal processor (DSP), or any combination thereof, that executes instructions to perform the operations described in the claims.

The term “user” refers to a human operator who interacts with the system, for example through a terminal, a website, or an application, and who provides input information for generating a travel plan.

The term “input information” refers to information provided by the user to the system, including at least one of a travel style, a budget, a physical strength, points emphasized by the user, travel dates, destinations, number of travelers, and other travel-related conditions or preferences.

The term “analyze” refers to processing the input information by performing at least one of parsing, validating, categorizing, normalizing, scoring, or otherwise interpreting the input information, in order to derive analysis results used for generating a prompt.

The term “prompt” refers to a text or machine-readable instruction sequence that encodes the user's conditions and preferences in a form suitable for input to a generative artificial intelligence model, and that instructs the generative artificial intelligence model to generate a travel plan.

The term “travel plan” refers to information describing at least one of destinations, accommodations, restaurants, attractions, activities, schedules, or transportation, arranged as a plan for a trip tailored to the user's conditions and preferences.

The term “generative artificial intelligence model” refers to a machine learning model, such as a large language model or other generative model, that generates new content including at least natural language descriptions of a travel plan in response to a prompt.

The term “budget” refers to a monetary amount or range indicating a financial constraint or preference of the user for the entire trip or for portions of the trip, such as accommodation, meals, and activities.

The term “physical strength” refers to a physical condition or activity tolerance level of the user, such as low, medium, or high, which is used to determine suitable intensity or difficulty levels of activities and attractions in the travel plan.

The term “points emphasized by the user” refers to one or more aspects that the user considers important for the trip, such as nature, culture, food, shopping, relaxation, or adventure, and that guide the selection and arrangement of elements in the travel plan.

The term “elements representing the budget, the physical strength, and the points emphasized by the user” refers to explicit tokens, phrases, or parameter values included in the prompt that express the user's budget, physical strength level, and emphasized points in a form interpretable by the generative artificial intelligence model.

The term “form on a website or an application” refers to a graphical or textual user interface component presented on a web page or within a software application, through which the user can enter and submit input information to the system.

The term “structured data” refers to data that has been organized into a predefined format, such as key-value pairs, tables, objects, or records, so that each piece of information is associated with a defined field or attribute for subsequent processing.

The term “analysis unit” refers to a functional module implemented by software, hardware, or a combination thereof, which performs analysis and conversion of raw user input into structured data usable by the processor for generating the prompt.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

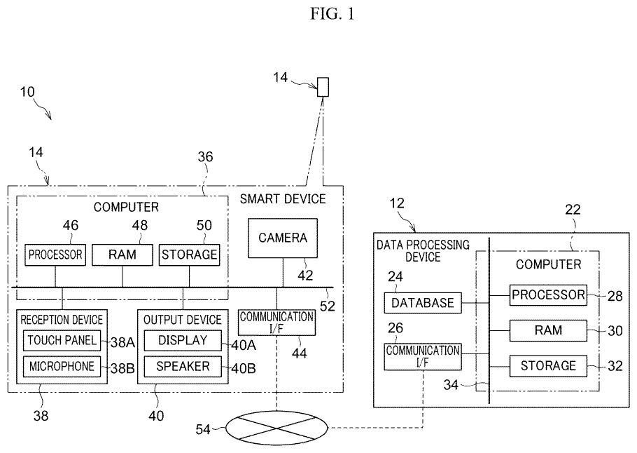

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

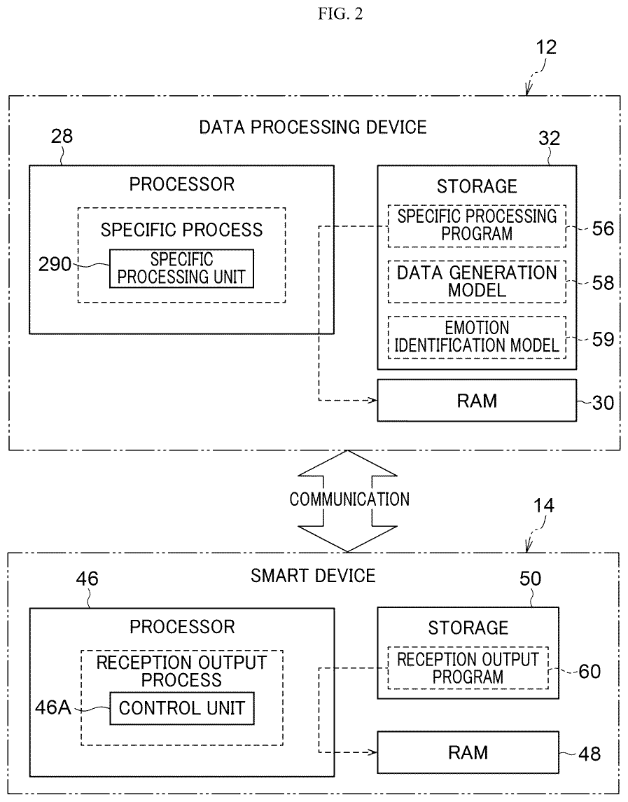

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems are typically configured to apply fixed rule sets or template-based search procedures to user input and to generate itineraries by querying databases of destinations, accommodations, and activities. Such systems have several technical limitations from the viewpoint of computer technology.

First, traditional systems generally process user input as shallow, unstructured text or as a small number of predetermined parameters, and they do not convert the input into standardized, machine-interpretable structured data that can be dynamically mapped to the behavior of a generative AI model. As a result, it is difficult to express complex constraints, such as detailed budget ranges, physical conditions, and priority items, in a way that can be consistently enforced throughout subsequent computational steps, thereby limiting the accuracy and reliability of automatically generated travel plans.

Second, even where generative AI models are used in existing systems, those models are often invoked with ad hoc text prompts that are manually crafted or only loosely formatted. Without systematic prompt construction, constraint encoding, and post-generation validation, the underlying information processing apparatus cannot reliably control the behavior of the generative AI model. This leads to technical problems including generation of itineraries that violate budget constraints, inconsistent numbers of days or time slots, and outputs that are not easily renderable by client devices in a standardized display structure. From the standpoint of computer system design, these problems manifest as increased error handling overhead, repeated manual corrections, and inefficient use of computational resources.

Third, conventional systems lack a closed-loop interaction between prompt generation, model invocation, and automated validation. In many architectures, once the generative AI model produces an output, the system either presents it directly to the user or relies on manual review.

There is no systematic mechanism for the processor to detect inconsistencies in the generated plan with respect to the structured input conditions and to automatically regenerate refined prompts that emphasize or correct specific constraint information. Consequently, the system cannot improve generation quality in an automated manner, and iterative refinement requires human intervention, which reduces throughput and scalability in server-side processing.

Fourth, existing systems frequently treat user feedback or modification requests as separate, loosely coupled operations, without integrating them into a unified data model that combines original structured conditions, generated plan data, and feedback. This prevents the processor from efficiently constructing revision prompts that preserve stable portions of the plan while selectively altering only certain constraints, such as budget or priority items. From the perspective of computer technology, the absence of this unified workflow degrades the consistency of stored data, complicates server-side logic, and hinders efficient reuse of computation results.

Fifth, the visualization of generated travel plans on client devices is often handled as a simple rendering of free-form text. Without converting the generated data into a standardized display data structure that supports dynamic presentations such as scroll displays, segmented views, and comparative displays, the system cannot fully exploit the capabilities of modern client hardware and software. This results in inefficient use of communication bandwidth, as the server transmits unstructured text requiring complex client-side parsing, and it complicates rendering logic on resource-constrained terminals.

Accordingly, there is a need for an improved computer-implemented system that: (i) converts user input related to travel into standardized structured data; (ii) algorithmically constructs prompt sentences that encode detailed output formats and constraints for a generative AI model; (iii) performs automated validation of generated travel plan data against the original structured conditions; (iv) automatically generates and re-transmits refined prompt sentences when inconsistencies are detected; (v) integrates user feedback into a systematic revision workflow; and (vi) converts generated travel plan data into standardized display data suitable for efficient, dynamic presentation on client devices. Such a system would improve the reliability, controllability, and computational efficiency of travel plan generation using generative AI models, thereby providing a concrete improvement in computer technology rather than merely automating a human mental process.

The specific processing by the specific processing unit 290 of the data processing device 12 in Example 1 is realized by the following means.

The present invention provides a server comprising a processor and a storage device, the processor being configured to acquire, via a communication interface, input information relating to travel conditions from a client device operated by a user; to extract, from the input information, a plurality of attributes including at least a travel type, budget information, physical condition, priority items, travel period, and destination region, and to convert the extracted attributes into standardized structured data; to generate, on the basis of the structured data, a prompt sentence that specifies an output format of a travel plan, the output format including an itinerary proposal for each travel day, activity contents for respective time zones, place names of activities, outline descriptions of the activities, and approximate costs, and conforming to at least a budget constraint and a physical condition; to transmit the generated prompt sentence, as request data, to a generative AI model disposed internally or externally, and to acquire travel plan data received from the generative AI model; to perform a verification on the acquired travel plan data by determining whether at least a number of travel days, a division of time zones, and a total cost are within condition ranges included in the structured data, and, when inconsistency is detected, to automatically generate a re-prompt sentence by adding condition emphasis information or correction condition information to the prompt sentence and to re-transmit the re-prompt sentence to the generative AI model; to store, in the storage device, the travel plan data that has passed the verification in association with the structured data; to convert the verified travel plan data into display data that is presentable on a display device as a travel plan divided by day and by time zone; and to distribute the display data to the client device. This enables a computer system to algorithmically control interaction with a generative AI model through structured prompt sentences and automated validation, thereby improving the reliability, consistency, and efficiency of machine-generated travel plans and enhancing the capability of the underlying computing apparatus to process constraint-rich user requirements and to present standardized, dynamically renderable travel plan information on client devices.

The term “processor” refers to a hardware information processing unit, such as a central processing unit or other computing circuitry, configured to execute instructions stored in a memory to perform one or more of the operations described herein.

The term “storage device” refers to a hardware data holding unit, such as a volatile memory, a non-volatile memory, or a combination thereof, configured to store programs, structured data, travel plan data, and display data for access by the processor.

The term “communication device” refers to a hardware communication interface, such as a network interface controller, wireless communication module, or wired communication port, configured to transmit and receive data between the server and one or more external devices over a communication network.

The term “client device” refers to an information processing terminal, such as a personal computer, a smartphone, a tablet, or another user-operated computing apparatus, configured to transmit user input information to the server and to receive and present display data.

The term “input information” refers to information relating to travel conditions that is provided by a user via a client device and transmitted to the server, including one or more attributes such as travel type, budget information, physical condition, priority items, travel period, and destination region.

The term “travel conditions” refers to constraints, preferences, and parameters relating to a planned travel, including at least travel type, budget information, physical condition, priority items, travel period, and destination region that influence generation of a travel plan.

The term “travel type” refers to a classification of a travel, such as a family trip, a solo trip, a group trip, a business trip, or another category indicating a general style or purpose of the travel.

The term “budget information” refers to one or more numerical or categorical values indicating monetary constraints of a travel, including at least a maximum total cost, and optionally per-day or per-category cost limits.

The term “physical condition” refers to information representing a user's physical capability or tolerance, including, for example, general fitness level, walking tolerance, or restrictions on physically intensive activities.

The term “priority items” refers to one or more preference categories or focus points specified by a user, such as hot springs, local food, nature, shopping, cultural experiences, or other thematic or functional priorities for the travel.

The term “travel period” refers to a temporal condition of the travel, including at least a number of travel days, and optionally start dates, end dates, or time ranges used to structure an itinerary.

The term “destination region” refers to a geographical condition of the travel, including at least a country, a state, a city, an area, or a combination thereof, used as a spatial constraint for the travel plan.

The term “structured data” refers to data that has been converted from raw input information into a standardized, machine-readable format, such as key-value pairs, lists, or records, in which attributes like travel type, budget information, physical condition, priority items, travel period, and destination region are explicitly represented.

The term “standardized structured data” refers to structured data that is normalized according to predetermined formats, units, and value ranges so that the processor can consistently interpret and use the data in prompt generation, validation, and storage processes.

The term “prompt sentence” refers to a machine-generated natural language instruction or query, including an indication of required output format and conditions, that is provided as input to a generative AI model to cause the model to generate travel plan data.

The term “re-prompt sentence” refers to a prompt sentence that is automatically generated by the processor in response to detection of inconsistency in generated travel plan data, the re-prompt sentence including added condition emphasis information or correction condition information to refine subsequent output of the generative AI model.

The term “revision prompt sentence” refers to a prompt sentence generated by the processor based on existing travel plan data and additional conditions or modification requests from a user, the revision prompt sentence being configured to cause the generative AI model to produce revised travel plan data while maintaining at least some constituent elements of the existing travel plan.

The term “generative AI model” refers to a machine-learned information processing model, such as a neural network-based generative model, configured to generate text, structured data, or other content in response to input including a prompt sentence, and that may be disposed internally within the server system or externally as a network-accessible service.

The term “generative information processing model” refers to a generative AI model or another content-generating computational model that receives request data including a prompt sentence and outputs generated travel plan data.

The term “request data” refers to data transmitted from the processor to the generative AI model, including at least one prompt sentence and, optionally, model parameters or context information, used to invoke the generative AI model.

The term “travel plan data” refers to data output from the generative AI model in response to a prompt sentence, representing at least an itinerary proposal, activities, locations, descriptions, and costs, and optionally additional metadata, prior to conversion into display data.

The term “revised travel plan data” refers to travel plan data generated by the generative AI model based on a revision prompt sentence that incorporates additional conditions or modification requests from a user and that partially modifies an existing travel plan.

The term “itinerary proposal” refers to a plan describing a sequence of activities, locations, or events for one or more travel days, including time-related or order-related structure.

The term “time zone” refers, in the context of a travel plan, to a time segment within a travel day, such as morning, afternoon, evening, or another temporal division, used to categorize and schedule activities.

The term “activity contents” refers to information describing actions or events to be performed by the traveler, including at least a type of activity, a location of the activity, an outline description, and optionally time and cost information.

The term “place name of activities” refers to a designation, such as a facility name, a geographic location name, or a landmark name, associated with a particular activity in a travel plan.

The term “outline description” refers to a short natural language explanation of an activity, location, or day in the travel plan that summarizes key characteristics or purposes.

The term “approximate costs” refers to estimated monetary values associated with one or more elements of the travel plan, including per-activity costs, daily costs, or total costs, which may be represented as ranges or single values.

The term “budget constraint” refers to a condition derived from budget information that defines an upper limit or permissible range of total or partial costs within which the generated travel plan should remain.

The term “condition ranges” refers to predetermined or dynamically computed allowed values or intervals of attributes such as number of travel days, total cost, or time zone divisions, derived from standardized structured data and used for validation of travel plan data.

The term “condition emphasis information” refers to additional data or wording added to a prompt sentence to highlight or enforce particular constraints, such as strict adherence to a budget constraint or travel period, in interaction with the generative AI model.

The term “correction condition information” refers to additional or modified constraint data added to a prompt sentence to correct previous inconsistencies or violations identified in generated travel plan data.

The term “verification” refers to an automated process performed by the processor to determine whether generated travel plan data satisfies one or more conditions or constraint ranges derived from structured data, such as checking consistency of travel days, time zone divisions, and total cost.

The term “display data” refers to data derived from travel plan data that has been transformed into a representation suitable for presentation on a display device, including layout structure, segmentation by day and time zone, and formatting information.

The term “standardized display format” refers to a predetermined visual or structural specification according to which display data is organized, such as headings by day, subdivisions by time zone, and lists or tables of activities and costs.

The term “display structure” refers to an internal representation of display data that defines the organization of elements for output, such as hierarchy of days and activities, segmentation, or comparison groups, which can be rendered by a client device.

The term “scroll display” refers to a display mode in which a travel plan is presented as a continuous vertically or horizontally scrollable view on a client device.

The term “segmented display” refers to a display mode in which elements of a travel plan, such as days or categories of activities, are separated into distinct sections, panels, or tabs on a client device.

The term “comparative display” refers to a display mode in which two or more travel plans, or two or more versions of a travel plan, are presented in a manner that allows visual comparison, such as side-by-side or overlaid presentation.

The term “additional conditions” refers to further constraints, preferences, or parameters provided by a user after an initial travel plan has been generated, which are intended to modify or refine the travel plan.

The term “modification requests” refers to user-provided instructions to change one or more aspects of an existing travel plan, such as increasing visits to certain activity types, reducing walking distances, or adjusting the budget constraint.

The term “constituent elements of an existing travel plan” refers to components of previously generated travel plan data, such as selected destinations, overall trip length, or day structure, that may be maintained while other aspects are revised.

The term “internally or externally disposed” refers to whether the generative AI model is implemented within the same computing environment as the server, such as on a local machine or in a local network, or provided as a remote service accessed over a communication network.

In the following description of embodiments, a data processing apparatus is referred to as a server, and a user-operated computing apparatus is referred to as a terminal. A human operator is referred to as a user.

The server is implemented by one or more hardware computer systems. The server includes at least one processor, a main memory, a non-volatile storage device, a communication interface, and a display interface. The processor is, for example, a general-purpose central processing unit, a graphics processing unit, or a combination thereof. The main memory is, for example, a random access memory. The non-volatile storage device is, for example, a solid-state drive or a magnetic disk drive. The communication interface is, for example, a wired or wireless network interface configured to communicate over an external network such as the Internet. The terminal is, for example, a personal computer, a tablet, or a smartphone that includes a display device, an input device, and a communication module. In some embodiments, the server executes a web application framework, such as a server-side JavaScript framework running on an operating system, and the terminal executes a web browser or a native application.

The server stores in the non-volatile storage device a travel-planning program and a set of auxiliary modules. The travel-planning program includes, as software components, at least a communication module, an input-structuring module, a prompt generation module, a generative AI interface module, a validation module, a storage management module, and a display-data generation module. The server loads these modules into the main memory, and the processor executes instructions of these modules to realize the functions described in the claims.

The server acquires user input information from the terminal via the communication interface.

The terminal transmits user input information using a network protocol such as HTTPS. The terminal displays, on its display device, an input screen implemented in markup language and script language, and the user operates the input screen to enter travel conditions, including a travel type, a budget amount, a physical condition level, priority items, a travel period, and a destination region. The terminal converts the input into a structured representation, for example, a set of key-value pairs, and transmits the representation to the server. By using a fixed schema on both the terminal and the server, the system avoids ambiguous free-form text at the network boundary and reduces parsing overhead on the server.

The server receives the user input information and converts it into standardized structured data.

The input-structuring module executed by the processor parses incoming data and maps each item into a predefined internal schema. For example, the server maps travel type into an internal category identifier, converts budget information into a normalized numeric range in a reference currency, maps physical condition into a discrete level representing permissible walking distance or activity intensity, and maps priority items into standardized feature identifiers used internally by the server. The server also normalizes the travel period into a number of days and, optionally, time-of-day segments such as morning, afternoon, and evening. The server stores the standardized structured data in the storage device in association with a request identifier. By normalizing such attributes into a common representation, the server reduces branching in downstream processing and enables vectorized comparison operations when validating generated plans, which results in improved computational efficiency.

The server generates a prompt sentence for a generative AI model on the basis of the standardized structured data. The prompt generation module executed by the processor synthesizes a natural language text that encodes both the user's constraints and a required output format. The server uses a template-based algorithm that combines fixed instruction segments and variable segments derived from the structured data. For example, the server generates a prompt sentence of the following form:

“You are a professional travel planner.

Please propose a detailed 3-day travel plan that satisfies the following conditions.
Travel style: family trip
Budget: within 100,000 JPY in total
Physical strength: low (avoid long walks and hard activities)
Priority points: hot springs, relaxation, short walking distance from accommodations
Destination preference: within Japan

### Requirements:

1. Provide a day-by-day itinerary (Dy 1, Day 2, Day 3).
2. For each day, describe the schedule in time order (morning, afternoon, evening).
3. For each activity, include: location name, brief description, and approximate cost.
4. Keep the total estimated cost within the budget.
5. Avoid activities that require high physical strength.

Output the result in English in a clear, structured list.”

The server constructs such prompt sentences using explicit markers for constraints and output structure. This explicit encoding allows the downstream generative AI model to produce outputs that can be more easily parsed and validated by the server. Unlike a human operator manually drafting descriptions, the server enforces consistent prompt style, order of constraint description, and explicit formatting instructions, which reduces variability in model output and thereby improves the reliability of automatic downstream checking.

The server interfaces with a generative AI model via the generative AI interface module. In some embodiments, the generative AI model is a neural network trained with a transformer architecture. The model includes multiple encoder-decoder or decoder-only layers, each layer including multi-head self-attention, feed-forward sublayers, and normalization layers. The server provides the prompt sentence to this model through an application programming interface. The server supplies the prompt sentence as tokenized text and sets model parameters such as temperature, maximum output length, and sampling strategy. The model has been pre-trained on a large corpus of text and further fine-tuned on instruction-following data. During inference, the model computes activations by applying linear transformations and non-linear activation functions to embedded token representations, and produces probability distributions over a vocabulary for each subsequent token. The server receives, via the communication interface, the output tokens that represent the generated travel plan data.

In some embodiments, the generative AI model is trained by supervised learning and reinforcement learning. During supervised learning, the model parameters are updated by minimizing a cross-entropy loss between predicted tokens and reference tokens. The model uses gradient-based optimization, such as stochastic gradient descent or an adaptive moment estimation algorithm, to update its weight matrices. During reinforcement learning, an additional value head and policy head are used, and the model's outputs are evaluated by a reward model that measures the quality of responses according to criteria such as factuality, coherence, and adherence to constraints. The reward signal is used to adjust the model parameters via policy gradient methods. As a result, the generative AI model can produce structured, instruction-following text that more accurately follows the constraints encoded in the prompt sentence. This training regime, combined with the structured prompt generation performed by the server, contributes to improved accuracy and consistency compared to conventional template-based itinerary generation.

The server performs validation of generated travel plan data using the validation module. The server analyzes the generated text by segmenting it into days and time-of-day sections according to markers or headings included in the output. The server extracts numeric values that represent costs and counts the number of days for which itineraries are described. The server compares these extracted values with the standardized structured data. For instance, if the structured data indicates a 3-day travel period with a budget limit of 100,000 JPY, the server verifies that the plan contains exactly three day segments and that the total approximate costs, obtained by summing extracted cost values, do not exceed the budget by more than a predetermined tolerance. When the server detects an inconsistency, such as missing day segments or an excessive estimated cost, the server does not simply display the plan to the user. Instead, the server automatically creates a re-prompt sentence that emphasizes or corrects the violated constraints.

The server generates the re-prompt sentence by adding condition emphasis information or correction condition information to the original prompt sentence. For example, when the budget limit is exceeded, the server may generate a re-prompt sentence of the following form:

“The previous plan exceeded the total budget limit of 100,000 JPY.

Revise the 3-day travel plan so that the total estimated cost is strictly within 100,000 JPY, while keeping the number of days and general destination region unchanged.

Output the revised plan in the same day-by-day format, with morning, afternoon, and evening activities and approximate costs.”

By introducing such re-prompt sentences, the server establishes a closed-loop control over the behavior of the generative AI model. In contrast to a human operator who would manually evaluate and redraft an entire itinerary, the server automatically identifies specific constraint violations, generates narrow corrective instructions, and re-invokes the generative AI model.

This closes the loop without human intervention and improves generation stability and computational efficiency. Since the server uses already structured conditions and parsing results, the corrective prompts can be automatically formed in a non-conventional manner that is tailored for machine-to-machine control rather than human-readable narrative.

The server manages data storage for both input conditions and generated travel plans using the storage management module. The server stores, in association with a request identifier, the standardized structured data, the prompt sentences, and one or more versions of the generated travel plan data. The server organizes these data in a normalized database schema that allows efficient indexing by user, date, and constraint categories. This structured storage supports incremental refinement of a travel plan. When the user later submits additional conditions or modification requests, the server can retrieve the existing travel plan data and combine it with the new conditions to form a revision prompt sentence. For example, the server may generate a revision prompt sentence such as:

“Here is the current 3-day travel plan:

[CURRENT PLAN TEXT]

The user provided the following feedback:

‘Please add more hot spring visits and reduce walking distances. Keep the budget under 120,000 JPY.’

Please revise the 3-day plan to:
Increase the number of hot spring visits.
Reduce total walking distance and avoid long walks.
Keep the total budget within 120,000 JPY.
Preserve the same 3-day structure and similar destinations if possible.

Output the revised plan in English, in the same day-by-day format.”

The server maintains links between old and revised plans and associated feedback. This relational structure allows the server to avoid recomputing the entire plan repository from scratch and reduces redundant use of computational resources in the generative AI model.

Moreover, by maintaining structured history, the server can analyze aggregated metrics such as typical constraint violation patterns and adjust the prompt templates or validation thresholds accordingly, which further improves plan generation quality and system throughput.

The server converts validated travel plan data into display data suited for dynamic rendering on the terminal. The display-data generation module constructs a logical display structure that includes, for each travel day, ordered activity elements with associated labels for time segments, location names, descriptions, and costs. The server then encodes this structure in a format suitable for efficient transmission and rendering, such as a compact, hierarchical representation.

By forming this display structure on the server, the system reduces the amount of client-side parsing required and thereby lowers the computational load on resource-limited terminals.

Additionally, the server can adapt the display structure to the characteristics of the terminal, for example, by generating a scroll-oriented structure for smartphones and a multi-column comparative structure for desktop displays.

The terminal receives the display data and renders it on the display device. The terminal uses a rendering engine in a web browser or a native graphical user interface framework to present the travel plan in user-friendly formats such as scroll displays, segmented displays by day or category, or comparative displays of multiple versions of a plan. Because the server transmits display data that has already been structured and validated, the terminal need not execute complex natural-language parsing or numeric validation. This division of labor leads to more efficient use of network bandwidth and terminal resources.

The system described above improves computer technology in multiple respects. The server not only automates a human activity of travel planning but also implements a non-conventional architecture in which user constraints are converted into standardized structured data, encoded as prompt sentences with explicit output formats, and then used to control a large-scale generative AI model in a closed-loop manner with automated validation and re-prompt generation. This architecture reduces the variability and error rates in generated itineraries, shortens the number of iterations required to obtain acceptable plans, and decreases communication overhead by transmitting structured display data instead of raw unstructured text. The server reduces processing time by performing vectorized comparisons on structured attributes and by reusing stored normalized data and partial computation results in iterative refinement. The system thereby yields improvements in processing speed, generation accuracy, and resource efficiency of computer hardware.

In addition, the use of a transformer-based generative AI model in combination with explicit prompt sentence construction constitutes more than an abstract idea. The server leverages specific characteristics of the model architecture, such as its ability to follow detailed instructions encoded in natural language, and constrains the model through machine-generated prompt sentences that are algorithmically derived from structured data. The server performs deterministic preprocessing and postprocessing steps that are tightly coupled to the model's token-level output format. For example, the server exploits the model's tendency to follow bullet-list formatting when explicitly requested, and parses the resulting stable structure. This design choice leads to a reduction in parsing complexity on the server, as compared to attempting to interpret arbitrary free-form descriptions, and thereby reduces CPU time and memory usage.

Multiple variations of the described embodiments are possible. In some embodiments, the server deploys the generative AI model locally on a specialized accelerator device, such as a graphics processing unit or a tensor processing unit, instead of calling an external service. In such cases, the server includes a dedicated model execution module that loads model parameters from the storage device into high-bandwidth memory and executes matrix multiplication kernels optimized for the hardware. In other embodiments, the server adapts the generation and validation strategy to different travel domains, such as business trips or educational tours, by altering the set of constraints and output formats encoded in the prompt sentences. The terminal can be realized as various form factors, including vehicle-integrated infotainment systems, where the travel plan is used to control navigation suggestions or prefetch map data, thereby linking the generated plan to control of real-world devices and further grounding the system's operation in technical effects.

The server may also employ different algorithms in the validation module. For example, the server may use pattern-matching algorithms to detect headings such as “Day 1” or “Morning” or may require the generative AI model to output a semi-structured text with explicit tags, such as “<day_1> to </day_1>”, so that the server can parse the output using deterministic string processing. By using such non-human-oriented but machine-friendly tags, the system departs from conventional human-centric text generation and implements an AI-to-computer protocol that increases parsing robustness and speed.

In all of these embodiments, the server, the terminal, and the generative AI model cooperate through the described data structures, modules, and algorithms to realize a technical system that improves the functioning of computers in generating, validating, storing, and displaying constraint-rich travel plans. The system is therefore not limited to mere automation of human travel planning but provides a concrete technical solution that enhances the performance, reliability, and efficiency of computing apparatuses used for such planning.

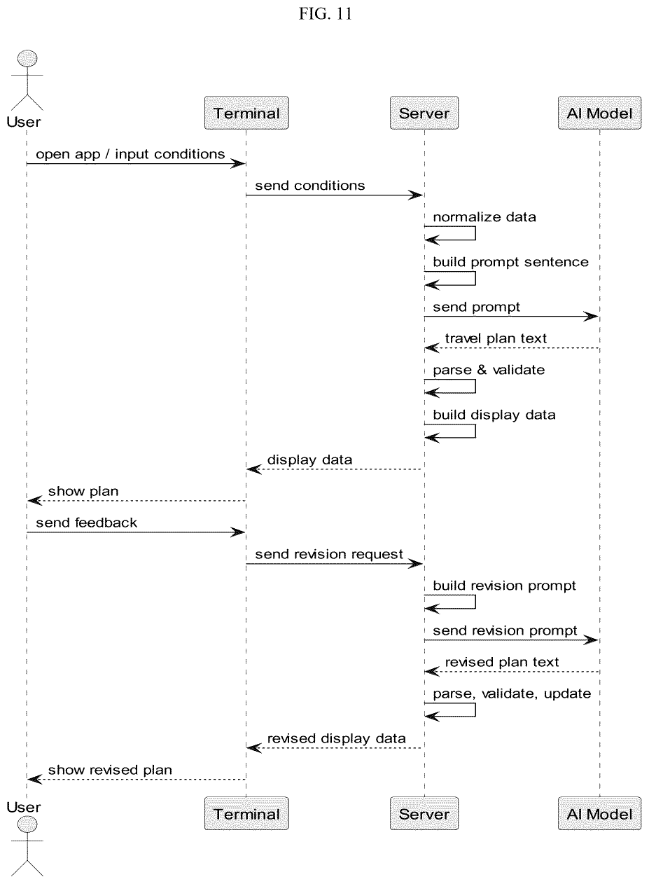

The following describes the processing flow using FIG. 11.

### Step 1:

User operates the terminal to open a travel planning screen and to input initial travel conditions.

User views input fields on the terminal for travel type, budget, physical condition, priority items, travel period, and destination region, and then enters or selects corresponding values.

Input: Raw user actions (taps, clicks, keystrokes) and partial text values.
Output: Completed input fields on the terminal's screen containing user-specified travel conditions.

### Step 2:

Terminal converts the completed input fields into a structured request object and performs client-side validation.

Terminal reads the values of each input field, maps them to predefined keys, and constructs a structured representation such as an internal key-value map. Terminal checks whether required fields are present, whether numeric values are in valid ranges, and whether categorical values belong to allowed sets. When invalid values are detected, terminal displays error messages and requests correction.

Input: Completed input fields containing user-specified travel conditions.

Output: Validated internal request object that represents the travel conditions as structured attributes.

### Step 3:

Terminal transmits the structured request object to the server via a secure communication channel.

Terminal serializes the internal request object into a data payload, attaches metadata such as timestamps and user identifiers, and sends the payload through a network stack using a protocol such as HTTPS to a predetermined server endpoint.

Input: Validated internal request object representing travel conditions.

Output: Network message delivered to the server containing serialized user travel conditions.

### Step 4:

Server receives the network message and reconstructs the structured travel condition data.

Server accepts the incoming connection through the communication interface, decodes the protocol headers, and extracts the serialized payload. Server parses the payload and reconstructs a server-side data structure that contains fields such as travel type, budget amount, physical condition level, priority items, travel period, and destination region.

Input: Serialized payload representing travel conditions.

Output: Server-side structured data object containing normalized travel condition fields in a machine-readable schema.

### Step 5:

Server standardizes and normalizes the structured travel condition data into a standardized structured data format.

Server converts units (for example, budget to a reference currency), maps textual categories (for example, physical condition strings) into discrete numeric or categorical codes, and resolves synonyms in priority items into standardized internal identifiers. Server also converts the travel period into a precise number of days and may derive default time segments such as morning, afternoon, and evening for each day.

Input: Server-side structured data object with raw travel condition fields.

Output: Standardized structured data object in which travel conditions are represented using normalized units, codes, and derived attributes suitable for algorithmic processing.

### Step 6:

Server stores the standardized structured data in a storage device and associates it with a request identifier.

Server generates or obtains a unique request identifier and inserts a new record into a persistent data store. The record includes the standardized structured data, timestamps, and user association data. Server maintains indexes on key fields, such as user identifier and request identifier, to support efficient retrieval.

Input: Standardized structured data object.

Output: Persistent database record identified by a request identifier and containing standardized structured data.

### Step 7:

Server constructs a prompt sentence based on the standardized structured data.

Server invokes the prompt generation module to combine fixed instruction templates and variable segments derived from the standardized structured data. Server inserts values such as number of days, budget limit, physical condition description, priority items, and destination region into the template, and appends explicit output formatting requirements.

Input: Standardized structured data object including travel type, budget, physical condition, priority items, travel period, and destination region.

Output: Prompt sentence in natural language that encodes constraints and required travel plan output format for a generative AI model.

### Step 8:

Server augments the prompt sentence with model control parameters and forms request data for the generative AI model.

Server creates a request package that includes the prompt sentence, a role designation for the model, and parameters such as maximum output length, temperature, and allowed tokens. Server formats this package according to the interface specification of the generative AI model.

Input: Prompt sentence generated from standardized structured data.

Output: Generative AI request data including the prompt sentence and associated generation parameters.

### Step 9:

Server transmits the generative AI request data to the generative AI model and initiates inference.

Server sends the request data via a network protocol to an external generative AI service or forwards it to an internal model execution module. Server passes the tokenized prompt to the model and initiates computation on the model's layers, which process the prompt sentence and generate output tokens.

Input: Generative AI request data including prompt sentence and model parameters.

Output: Streaming or batch response from the generative AI model containing generated tokens that represent travel plan text.

### Step 10:

Server receives the generated output tokens and reconstructs the travel plan text as travel plan data.

Server collects the output tokens from the generative AI model, converts them back into characters and words using a tokenizer's vocabulary mapping, and concatenates these into coherent text. Server may trim trailing incomplete segments and apply basic normalization to whitespace and punctuation.

Input: Generated tokens output by the generative AI model.

Output: Travel plan data in text form that describes an itinerary according to the prompt sentence.

### Step 11:

Server segments the travel plan data and extracts structural elements for validation.

Server scans the travel plan text for headings such as “Day 1,” “Day 2,” and labels such as “Morning,” “Afternoon,” and “Evening.” Server divides the text into segments for each day and each time segment. Server then applies pattern matching or simple parsing rules to locate cost values and associates each cost value with its corresponding activity segment.

Input: Travel plan data in text form.

Output: Parsed travel plan structure containing a list of days, time segments, activities, locations, descriptions, and extracted cost values.

### Step 12:

Server validates the parsed travel plan structure against the standardized structured data.

Server compares the number of days in the parsed structure with the travel period in the standardized structured data, verifies that the expected time segments exist for each day, and computes an estimated total cost by summing extracted cost values. Server then compares the estimated total cost with the budget constraint and evaluates other constraints such as physical condition (for example, detecting excessive numbers of walking-intensive activities based on keywords or activity categories).

Input: Parsed travel plan structure and standardized structured data object.

Output: Validation result indicating whether all constraints are satisfied and, if not, a list of detected inconsistencies such as incorrect number of days or budget overruns.

### Step 13:

Server generates a re-prompt sentence when inconsistencies are detected.

Server analyzes the list of inconsistencies and determines which constraints were violated.

Server then takes the original prompt sentence and appends or inserts explicit statements that emphasize the violated constraints or specify correction conditions. For example, for a budget violation, server adds a sentence requiring the total cost to be strictly within the budget. For a day-count error, server explicitly instructs the model to produce exactly the specified number of days.

Input: Original prompt sentence and validation result including detected inconsistencies.

Output: Re-prompt sentence that refines or emphasizes specific constraints in order to correct the travel plan data in a subsequent generation.

### Step 14:

Server re-invokes the generative AI model using the re-prompt sentence when validation fails.

Server constructs new generative AI request data that replaces the previous prompt sentence with the re-prompt sentence while retaining appropriate model parameters. Server transmits this new request to the generative AI model and repeats generation and reconstruction of travel plan data.

Input: Re-prompt sentence and associated model parameters.

Output: New travel plan data generated by the generative AI model that is expected to better satisfy the constraints.

### Step 15:

Server selects validated travel plan data for storage and for use in display generation.

Server checks whether the newly generated travel plan data passes validation. If it does, server designates this travel plan data as the accepted plan for the corresponding request identifier.

Server stores the accepted travel plan text and parsed structure in the storage device, linked to the standardized structured data and user information.

Input: One or more versions of generated travel plan data and associated validation results.

Output: Persistent storage record containing the accepted travel plan and its parsed structure associated with the original request identifier.

### Step 16:

Server generates display data from the accepted travel plan structure for efficient rendering on the terminal.

Server transforms the parsed structure into a hierarchical display representation that organizes data by day and by time segment. Server attaches presentation attributes such as labels, ordering indices, and summarization strings. Server may also compute derived statistics, such as per-day cost totals, to be included in the display data.

Input: Accepted parsed travel plan structure and standardized structured data.

Output: Display data structure optimized for rendering, containing ordered days, time segments, activities, locations, descriptions, and per-activity and per-day cost information.

### Step 17:

Server transmits the display data to the terminal via the communication interface.

Server encapsulates the display data structure into a transmission payload, adds identifiers such as request identifier and plan version identifier, and sends the payload over the network to the terminal. Server may compress the payload or apply encoding optimizations to reduce communication overhead.

Input: Display data structure associated with an accepted travel plan.

Output: Network message delivered to the terminal containing display data for the travel plan.

### Step 18:

Terminal reconstructs the display data and renders the travel plan on the display device.

Terminal receives the payload, decodes the transmission format, and reconstructs the hierarchical display representation. Terminal maps the representation to user interface components such as day sections and time-segment cards. Terminal then draws the travel plan onto the display device, enabling scrolling, section switching, or comparative views according to the display structure.

Input: Display data structure received from the server.

Output: Visual presentation of the travel plan on the terminal's display, segmented by day and time segment with visible activity details and costs.

### Step 19:

User reviews the displayed travel plan and optionally inputs additional conditions or modification requests.

User inspects daily itineraries, activities, and cost information shown on the terminal, and determines whether changes are desired. User then enters additional instructions, such as requests for more specific activity types, different budget limits, or reduced walking intensity, into a feedback input area displayed by the terminal.

Input: Visualized travel plan and user's evaluation.

Output: New feedback text or revised condition values entered into the terminal's input elements.

### Step 20:

Terminal packages the additional conditions or modification requests and sends them to the server for plan revision.

Terminal reads the user's feedback text and any newly entered constraint values, combines them with identifiers of the existing travel plan, and constructs a revision request object. Terminal validates that the feedback is non-empty and that any numeric data is well-formed, and then transmits the revision request object over the network to the server.

Input: User feedback text and plan identifiers associated with the current travel plan.

Output: Network message delivered to the server containing revision request data.

### Step 21:

Server generates a revision prompt sentence using the stored travel plan data and the additional conditions.

Server retrieves the stored travel plan text and the standardized structured data corresponding to the plan identifiers. Server concatenates a representation of the current plan and the user's feedback text into a single instruction context and constructs a revision prompt sentence that instructs the generative AI model to preserve certain elements (such as number of days and general destination region) while altering other aspects (such as costs, activity types, or walking intensity).

Input: Stored travel plan text, standardized structured data, and revision request data with additional conditions.

Output: Revision prompt sentence that combines existing plan content and new user-specified modifications for the generative AI model.

### Step 22:

Server transmits the revision prompt sentence to the generative AI model and obtains revised travel plan data.

Server forms generative AI request data that includes the revision prompt sentence and suitable model parameters, sends it to the generative AI model, and receives new output tokens representing a revised plan. Server reconstructs the revised travel plan text and parses it into a structured representation in the same manner as for the initial plan.

Input: Revision prompt sentence and model parameters.

Output: Revised travel plan data in textual and parsed structured forms.

### Step 23:

Server validates, stores, and distributes the revised travel plan data in the same manner as for the initial plan.

Server applies validation rules to the revised parsed structure, confirms that the revised plan satisfies both the original structured conditions and the additional conditions, and if successful, stores the revised plan as a new version associated with the same request identifier. Server generates updated display data from the revised plan and sends it to the terminal.

Input: Revised parsed travel plan structure and validation criteria derived from original and additional conditions.

Output: Updated display data structure for the revised travel plan and stored record of the revised plan, which the terminal subsequently renders to present updated itineraries to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented travel planning systems typically rely on fixed rule sets, static recommendation engines, or manually curated templates. Such systems exhibit limited ability to adapt itinerary generation logic to diverse user constraints, such as nuanced travel styles, complex budget conditions, user-specific physical tolerance, and dynamically changing user preferences. As a result, the generated plans are often generic, fail to align with a user's actual constraints, and require substantial manual adjustment by the user.

Furthermore, in many existing systems, user input is passed to a remote recommendation engine in an ad hoc, unstructured manner. For example, unstructured free-text inputs or loosely formatted parameters are forwarded directly to a remote service without consistent pre-processing. This often leads to sub-optimal utilization of remote generative models, because the models do not receive well-structured, machine-optimized prompt sentences. Consequently, the models may generate itineraries that are incomplete, ambiguous, or misaligned with user conditions, which degrades the effectiveness and efficiency of the underlying computer system.

In addition, conventional systems generally lack a feedback-aware processing loop at the system level. Even when a user modifies a proposed itinerary or issues refinement requests, the system frequently handles such feedback as a separate transaction, without systematically correlating the new input with previously generated plans and stored constraints. The absence of a structured association between original conditions, generated itineraries, user modifications, and reservation operations prevents the system from constructing prompts that fully exploit historical interaction context. This leads to repetitive user input, redundant computation, and increased latency and resource consumption in the server and associated communication network.

Moreover, there is a technical challenge in transforming the inherently unstructured natural language output of a generative AI model into structured schedule information that can be efficiently stored, indexed, retrieved, and rendered by the server and the user terminal. Without a defined mechanism for parsing and restructuring the model output into machine-usable schedule objects, the system cannot perform downstream processing such as cost aggregation, day-by-day activity organization, version management, and reservation linkage in a robust and scalable manner.

Thus, from a computer technology standpoint, there is a need for an improved server-side processing architecture that: (i) systematically converts heterogeneous user inputs into structured condition information; (ii) generates optimized natural language prompt sentences for a generative AI model; (iii) converts the model's unstructured travel schedule output into structured schedule information; and (iv) maintains persistent associations between user conditions, prompts, generated plans, and user feedback. Such an architecture should enhance the efficiency, accuracy, and adaptability of itinerary generation, reduce redundant processing, and improve the overall performance of the computer system in generating and updating travel plans.

The specific processing by the specific processing unit 290 of the data processing device 12 in Application Example 1 is realized by the following means.

The present invention provides a server comprising a processor configured to acquire condition information related to travel from a user terminal, analyze the acquired condition information to generate structured information including at least a travel style, an expenditure condition, a physical tolerance level, and an evaluation priority item, generate, on the basis of the structured information, a prompt sentence in a natural language for instructing generation of a travel schedule proposal, record the prompt sentence as history information, transmit the prompt sentence to a generative AI model and obtain, from the generative AI model, a response including travel schedule information, analyze the travel schedule information included in the response and convert the travel schedule information into structured schedule information including behavior information on a per-day basis or a per-activity basis and cost information, convert the structured schedule information into presentation information in a format suitable for display on the user terminal and transmit the presentation information to the user terminal, acquire a change request or reservation operation information from a user with respect to the presentation information and record the change request or reservation operation information in association with the condition information and the travel schedule information, and modify the prompt sentence on the basis of the change request and obtain updated travel schedule information by retransmitting a modified prompt sentence to the generative AI model. This enables the computer system to (i) systematically structure user constraints before invoking a generative AI model, (ii) provide the generative AI model with optimized prompt sentences that reflect both current conditions and historical interaction context, (iii) convert unstructured model output into structured schedule data suitable for efficient storage, retrieval, and rendering, and (iv) iteratively refine travel plans in response to user feedback while maintaining explicit associations between inputs, prompts, outputs, and reservations, thereby improving the technical performance, adaptability, and resource efficiency of the travel planning system.

The term “processor” refers to an information processing element, such as a central processing unit or another computing circuitry, that executes instructions to perform the operations described in the system.

The term “user terminal” refers to an information processing apparatus, such as a mobile device, a portable computer, or a stationary computer, that provides a user interface for inputting condition information and displaying presentation information.

The term “condition information” refers to information related to travel that is provided by a user, including at least a travel style, an expenditure condition, a physical tolerance level, and an evaluation priority item.

The term “travel style” refers to a classification of a user's preferred manner of travel, including desired types of locations, activities, or experiences, such as nature-oriented travel, urban sightseeing, or cultural exploration.

The term “expenditure condition” refers to an allowable financial range or constraint for a travel plan, including upper limits on total cost or on specific categories of cost such as transportation, accommodation, or activities.

The term “physical tolerance level” refers to an indication of a user's physical capability to perform activities during travel, including an allowable amount of walking, hiking, or other physical exertion.

The term “evaluation priority item” refers to a factor or aspect of travel that a user regards as important when evaluating a travel plan, including, for example, activity intensity, relaxation, sightseeing variety, or cost efficiency.

The term “structured information” refers to data that has been organized according to a predetermined format or schema, such that individual elements, including the travel style, the expenditure condition, the physical tolerance level, and the evaluation priority item, are explicitly represented as distinct fields or attributes.

The term “prompt sentence” refers to a natural language text that is generated on the basis of structured information and that instructs a generative AI model to generate a travel schedule proposal.

The term “history information” refers to stored information representing one or more prompt sentences, and optionally associated metadata, that have been generated and used for obtaining travel schedule information from a generative AI model.

The term “generative AI model” refers to a machine learning model that receives a prompt sentence in natural language as input and outputs generated natural language text including a travel schedule proposal.

The term “travel schedule information” refers to information indicating a sequence of travel-related activities, locations, and time allocations generated by a generative AI model in response to a prompt sentence.

The term “structured schedule information” refers to travel schedule information that has been converted into a data structure organized by units such as days or activities, and that includes fields representing behavior information and cost information.

The term “behavior information” refers to information describing actions or activities to be performed during travel, including, for example, visit destinations, time slots, and activity descriptions on a per-day basis or a per-activity basis.

The term “cost information” refers to information representing monetary amounts associated with one or more elements of a travel schedule, including total cost and cost breakdowns for transportation, accommodation, and activities.

The term “presentation information” refers to data derived from structured schedule information that is formatted in a manner suitable for display on a user terminal, including layout, ordering, and grouping of schedule elements.

The term “change request” refers to information indicating a user's desire to modify at least part of a presented travel schedule, including requests to adjust activities, change costs, alter physical burden, or modify travel dates.

The term “reservation operation information” refers to information indicating a user's selection of specific schedule elements for booking, including selected dates, facilities, and activities associated with a travel schedule.

The term “association” refers to a logical linkage among condition information, prompt sentences, travel schedule information, change requests, and reservation operation information, such that related data items can be jointly identified and processed.

The term “identification information” refers to data, such as an identifier or key, used to uniquely or distinctively associate structured schedule information, reservation operation information, and related historical data items with each other.

In one embodiment, a server implements the claimed system as a network-connected computing apparatus that cooperates with one or more terminals operated by users. The server includes at least one processor, a main memory, a non-volatile storage device, and a network interface, and executes an application program that performs structured data processing for travel plan generation using a generative AI model. The terminal includes a processor, a display, an input device such as a touch panel or keyboard, a memory, and a communication interface. The user operates the terminal to provide condition information and to view and modify generated travel plans.

The server uses a general-purpose operating system, such as a Unix-like server operating system, and an application layer implemented using a programming language, such as Python, together with a web application framework, such as a micro web framework. The server further uses a data management system, such as a relational database management system, and a client library that enables the server to access a remote generative AI model via a network. The generative AI model is implemented as a neural-network-based language model, for example a transformer-based autoregressive model trained on large-scale text data.

The server maintains, in the database, tables that store condition information, prompt sentences, travel schedule information, structured schedule information, and reservation operation information. For example, the server defines a first table that stores records containing a request identifier, a user identifier, a travel style field, an expenditure condition field, a physical tolerance level field, and an evaluation priority item field. The server defines a second table that stores prompt sentences associated with each request identifier, and a third table that stores generated travel schedule information and corresponding structured schedule information linked to the request identifier. The server optionally defines a fourth table that stores reservation operation information associated with structured schedule entries.

The server analyzes condition information received from the terminal and converts the condition information into structured information. The server represents the structured information as a typed data structure in memory, for example an object or record with explicit fields for travel style, expenditure condition, physical tolerance level, and evaluation priority item. The server stores this structured information into the database with an associated identification value. By converting free-form user input into structured information, the server enables consistent indexing, efficient querying, and deterministic mapping from user conditions to prompt sentences.

The server generates a prompt sentence in a natural language on the basis of the structured information. The server uses a template-based generation mechanism in which predetermined textual patterns are combined with field values from the structured information. For example, the server can generate a prompt sentence of the form:

“User's travel style: I want to enjoy nature

Budget: Within 100,000 yen

Physical strength: I am confident in my stamina

Prioritized points: Active experiences

Please propose a recommended travel plan.”

In another example, the server can generate a more detailed prompt sentence of the form:

“You are a professional travel planner.

Create a 3- to 5-day travel itinerary that fits the following conditions.

Travel style: The user wants to enjoy nature (mountains, forests, lakes, or seaside).

Budget: Within 100,000 yen including accommodation and transportation.

Physical strength: The user is confident in their stamina and can handle long walks and light hiking.

Prioritized points: Active experiences, outdoor activities, and memorable local experiences. Output the plan in the following format:
1. Overview (1 paragraph)
2. Daily schedule (Day 1, Day 2, with time slots and destinations)
3. Estimated cost breakdown (transportation, accommodation, activities)
4. Notes and tips for the traveler.”

The server records each generated prompt sentence as history information into the prompt table, together with metadata such as timestamps, a reference to the structured condition information, and version identifiers. The server thereby builds a persistent association between user conditions and the exact natural language instructions that are issued to the generative AI model.

This association enables later refinement and audit of the generative AI interaction.

The server accesses the generative AI model through a network interface by sending the prompt sentence as part of a request. The generative AI model is implemented on remote hardware that includes multiple processing units, such as graphics processing units or tensor accelerators, and performs neural network inference according to a transformer architecture. The model internally represents the prompt sentence as a sequence of tokens and applies multiple layers of self-attention and feed-forward computations. The model uses learned parameter matrices (weights) that were obtained by minimizing a loss function, such as a cross-entropy loss, during a training phase on a large corpus of text data. In training, the model updated its parameters via gradient-based optimization, such as stochastic gradient descent or variants thereof, using backpropagation to propagate errors from predicted tokens to earlier layers.

During inference, the generative AI model calculates probability distributions over possible next tokens conditioned on previous tokens and selects successive tokens according to a decoding policy, such as greedy decoding or sampling with a specified temperature parameter. The model's output is thus a sequence of tokens converted back into natural language text, which constitutes travel schedule information. The server receives this travel schedule information as a text response. The use of a transformer-based generative AI model allows the server to exploit high-dimensional contextual representations and long-range dependencies in the prompt sentence, which enhances the accuracy and richness of the generated itinerary compared with conventional rule-based or template-based systems.

The server converts the unstructured travel schedule information into structured schedule information using a deterministic parsing procedure. The server, for example, scans the generated text for explicit markers such as “Day 1,” “Day 2,” or time notations, and segments the text accordingly. The server assigns each segment to a schedule unit, such as a daily schedule object, and extracts behavior information and cost information by pattern matching and keyword-based extraction. The server can use regular expressions to detect currency values, time ranges, and location names, and maps these values to fields of structured schedule entries.

The structured schedule information may represent each day as a record including date, list of activities, start and end times, location identifiers, and cost breakdowns. By converting text into structured schedule information, the server enables efficient storage, searching, and numerical operations, such as summing costs and checking for budget compliance.

The terminal receives the presentation information based on the structured schedule information and displays it on a graphical user interface. The terminal may present the schedule as a multi-panel view with a summary section, a day-by-day timeline, and a cost overview. The user can view the schedule, scroll through days, and select items for more detailed information. When the user wishes to modify the plan, the user can activate controls on the terminal, such as text fields and buttons, to indicate changes. For example, the user can input a request such as “reduce walking and add a hot spring day,” or select checkboxes that indicate “shorter walking distance” and “more relaxation.” The terminal transmits this change request to the server, together with identification information that identifies the relevant schedule.

The server receives the change request and uses the stored association between the structured schedule information, the original condition information, and the history of prompt sentences to construct a revised prompt sentence. For example, the server can generate a revised prompt of the form:

“Original conditions:

Travel style: The user wants to enjoy nature.

Budget: Within 100,000 yen.

Physical strength: The user is confident in their stamina.

Prioritized points: Active experiences.

Previous plan (summary):

[Summary of the existing plan here.]

User's new request:
Reduce the total walking time per day.
Add one day focused on hot springs and relaxation.

Please revise the previous travel plan to satisfy the new request.

Output the updated daily schedule, a short explanation of how physical burden is reduced, and an updated cost estimate.”

The server records this revised prompt sentence with a new version identifier and retransmits the revised prompt to the generative AI model. The generative AI model performs inference once again, generating a new itinerary that reflects both the original conditions and the explicit modifications. The server parses the new itinerary in the same manner as described previously, updates the structured schedule information in the database, and returns updated presentation information to the terminal. The user can then compare versions, confirm changes, and proceed to reserve specific elements.

The server manages reservation operation information by linking user selections, such as specific accommodations or activities, to corresponding entries in the structured schedule information. The server stores this reservation operation information in a dedicated table with foreign keys to the schedule entries. The server can then ensure consistency between subsequent refinements of the plan and already confirmed reservations. For example, if the user modifies the schedule after booking a hotel, the server can maintain the hotel reservation as a constraint in further prompt sentences, ensuring that the generative AI model proposes updated plans that respect the existing reservation.

The system provides technical improvements over conventional travel planning systems by implementing a specific data flow and set of algorithms optimized for interaction with a generative AI model. The server, by converting heterogeneous user inputs to structured condition information and then to carefully constructed prompt sentences, reduces ambiguity and variability in the input to the generative AI model. This structured prompting improves the relevance and completeness of the generated text and reduces the number of iterations needed to obtain an acceptable plan. As a result, the server decreases total communication overhead with the generative AI model and lowers processing time on the remote inference hardware.

Moreover, the server's parsing and structuring of the generative AI output into machine-readable schedule objects enables efficient indexing, caching, and incremental update operations. For example, the server can reuse parts of a schedule that remain unchanged between versions and only request modifications for affected segments in subsequent prompt sentences. The server thereby reduces redundant computation and data transfer, which improves response latency and reduces network load. The structured representation also enables the server to detect and correct inconsistencies or errors in the generative AI output by applying rule-based checks on fields such as dates, times, and total costs.

The system is not merely automating a human travel agent's task but is modifying and controlling the operation of computer resources through specific algorithmic steps. The server uses predetermined templates, data schemas, and parsing rules that are tailored to the structure of transformer-based language models and to the expected format of their outputs. These steps are not conventional manual procedures; instead, they constitute a non-traditional pipeline that exploits the generative AI model's high-dimensional feature space while constraining its outputs in a form suitable for deterministic post-processing. The combination of structured pre-processing, prompt optimization, and structured post-processing yields technical effects such as improved computation efficiency, improved accuracy of generated schedules under complex constraints, and reduced need for repeated full-plan regeneration.

In another embodiment, the server can adjust parameters used in the generative AI inference, such as temperature or maximum token length, based on characteristics of the structured condition information or user feedback. For instance, the server can lower the temperature parameter for users who prefer predictable and conservative itineraries, thereby reducing variability and potential errors in the generated plan. The server can also reduce the maximum token length when only minor modifications are requested, which shortens inference time and lowers computational load. These adaptive controls further optimize the use of computing resources in the remote generative AI system.

In yet another embodiment, the server can incorporate an intermediate scoring mechanism for candidate prompt sentences. The server can maintain, in the database, statistics such as previous user satisfaction ratings, frequency of subsequent modifications, and average inference latency associated with different prompt templates. The server can compute a score for alternative prompt templates by applying a heuristic or learned model and select the prompt template expected to produce the most accurate and efficient response. This feedback-driven optimization of prompt construction enhances technical performance by systematically improving the interaction pattern with the generative AI model across multiple users and sessions.

The terminal can be implemented in various forms, including a smartphone application, a tablet application, or a web browser-based interface on a desktop computer. The terminal can locally cache portions of presentation information, such as daily schedules already viewed by the user, to reduce repeated network requests to the server. The terminal can also perform local formatting operations, such as dynamic layout adjustments and timeline visualizations, based on structured schedule information received from the server. By distributing processing tasks between the server and the terminal, the system reduces overall latency and enhances responsiveness.

The described embodiments can be implemented in alternative configurations. For example, the generative AI model can be hosted on-premises rather than on a remote cloud service, in which case the server and the generative AI model can operate on a common physical machine or on machines connected by a local network. In another variation, the database can be a distributed data store that replicates structured schedule information across multiple nodes for fault tolerance and load balancing. The server architecture can be scaled horizontally by deploying multiple application instances behind a load balancer, each instance executing the same processing logic on different subsets of user requests.

By explicitly defining data structures, processing modules, and interaction patterns with the generative AI model, the system provides a concrete technical implementation that enables others skilled in the art to realize and deploy the invention. The server, terminal, and user cooperate through these technical mechanisms to generate, refine, and manage travel plans with improved computational efficiency, improved accuracy of constraint satisfaction, and reduced network and processing overhead compared with conventional systems that lack structured prompt generation and structured post-processing of generative AI outputs.

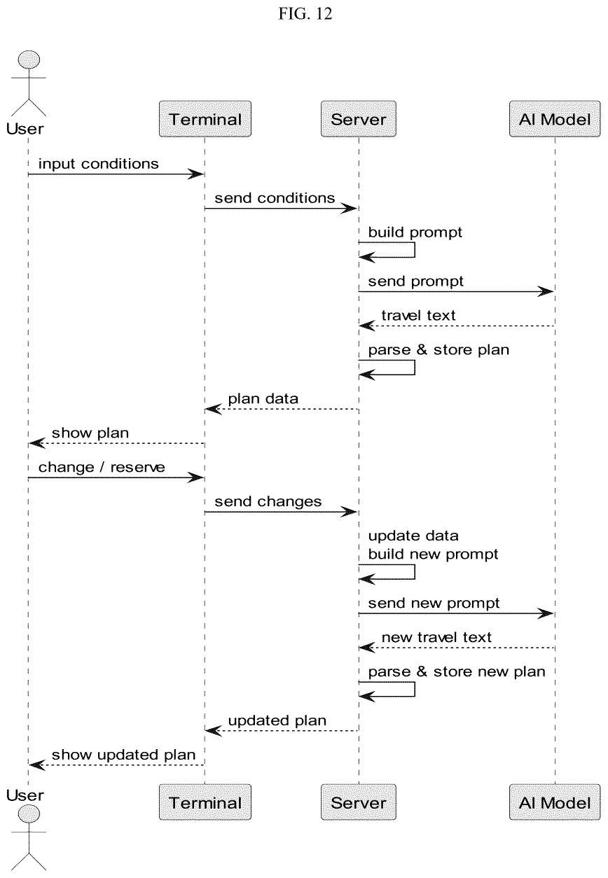

The following describes the processing flow using FIG. 12.

### Step 1:

User operates the terminal to open a travel planning interface and input condition information.

User provides, as input, text and selection values such as travel style, expenditure condition, physical tolerance level, and evaluation priority items through form fields on the terminal display. Terminal validates the format of the input (for example, checking that numeric fields are within allowed ranges and that mandatory fields are not empty) and normalizes the input (for example, trimming whitespace and converting currency strings to a standard format). Terminal then generates a structured message, for example a JSON object, that includes the condition information and a user identifier, and transmits this message to the server over a network connection as an HTTP request. The output of this step is a validated and formatted request message containing the user's condition information, delivered from the terminal to the server.

### Step 2:

Server receives the request message and converts the condition information into structured information.

Server accepts, as input, the HTTP request containing the user's condition information and parses the message body to extract fields such as travel style, expenditure condition, physical tolerance level, and evaluation priority items. Server performs backend validation and, based on the extracted fields, constructs a structured data object with explicitly typed attributes (for example, a record or row with separate columns for each attribute). Server writes this structured data object into a database table, generating or obtaining a request identifier as a primary key.

The output of this step is a stored structured condition record that can be retrieved by request identifier for subsequent processing.

### Step 3:

Server generates a prompt sentence in a natural language based on the structured information.

Server reads, as input, the structured condition record from the database or from memory using the request identifier. Server applies a template generation process in which the structured attributes (travel style, expenditure condition, physical tolerance level, and evaluation priority items) are substituted into predetermined text templates. Server concatenates the template text segments and the attribute values to form a coherent prompt sentence that instructs generation of a travel schedule proposal. For example, the server generates a prompt sentence such as:

“User's travel style: I want to enjoy nature

Budget: Within 100,000 yen

Physical strength: I am confident in my stamina

Prioritized points: Active experiences

Please propose a recommended travel plan.”

Server stores the generated prompt sentence and associated metadata (request identifier, timestamp, template identifier) into a prompt history table. The output of this step is a stored prompt sentence linked to the structured condition information and ready to be sent to a generative AI model.

### Step 4:

Server transmits the prompt sentence to the generative AI model and obtains travel schedule information.

Server retrieves, as input, the stored prompt sentence from the prompt history table and prepares an API call to a generative AI model hosted on remote hardware. Server packages the prompt sentence as a text payload, together with model configuration parameters such as model name, maximum token count, and temperature, and sends this payload through a network interface using a secure communication protocol. The generative AI model executes neural network inference on the prompt sentence, performing tokenization, attention-based processing, and probabilistic token generation according to trained parameters. The generative AI model outputs a sequence of tokens that is decoded into natural language text representing travel schedule information. Server receives this text as a response message from the model. The output of this step is a block of unstructured travel schedule text that corresponds to the prompt sentence and is associated with the request identifier.

### Step 5:

Server parses the travel schedule information and converts it into structured schedule information.

Server takes, as input, the unstructured travel schedule text received from the generative AI model. Server performs parsing and data extraction processing, including splitting the text at markers such as “Day 1,” “Day 2,” and specific time indicators, and scanning for cost expressions and location names. Server uses pattern matching rules and regular expressions to identify behavior information (for example, activities, locations, time ranges) and cost information (for example, monetary values and category-specific costs). Server then assembles these extracted elements into a structured schedule representation, such as a collection of day records, each day record containing an ordered list of activities with associated times, locations, and costs. Server stores the structured schedule information in a schedule table in the database, linking each schedule entry to the request identifier and, optionally, to a version identifier. The output of this step is structured schedule information that can be efficiently queried and used for presentation and reservation management.

### Step 6:

Server generates presentation information suitable for display on the terminal and sends it to the terminal.

Server reads, as input, the structured schedule information from the database. Server organizes the data into a presentation-oriented structure, grouping schedule entries into sections such as overview, daily schedule, and cost summary. Server may compute additional derived values, such as total trip cost or total number of activities per day, by performing arithmetic operations on the cost fields and counting the number of activities. Server formats the data into a representation suitable for the terminal, for example by structuring it as a hierarchical data object that mirrors the intended user interface layout. Server then transmits this presentation information to the terminal as a response to the original request, including identifiers that allow the terminal to request further updates. The output of this step is a formatted presentation payload that the terminal can render as a user-friendly travel plan.

### Step 7:

Terminal receives the presentation information and displays the travel plan to the user.

Terminal obtains, as input, the presentation payload sent by the server. Terminal parses the payload and updates its user interface components, such as lists, calendars, and text areas, to display the overview, daily schedules, and cost breakdown to the user. Terminal may perform local formatting operations, such as arranging activities on a timeline or grouping them by day, based on the structured layout indicated in the presentation information. Terminal renders this information on the display so that the user can scroll, expand, and inspect individual schedule entries. The output of this step is a visual representation of the travel plan on the terminal screen, enabling the user to understand the generated schedule and consider modifications or reservations.

### Step 8:

User reviews the travel plan, issues a change request, or performs reservation operations through the terminal.

User takes, as input, the visual representation of the travel plan displayed on the terminal and interacts with the interface to express preferences. User may input a textual change request such as “reduce walking and add a hot spring day,” or may select specific schedule entries to be reserved, such as choosing a particular accommodation or activity. Terminal captures these interactions as structured change request data or reservation operation data, including references to the schedule entries (for example, by using identifiers), and optionally associated free-text comments. Terminal then transmits this data to the server as a new network request that includes the request identifier and any relevant schedule identifiers. The output of this step is a change request message or reservation operation message delivered from the terminal to the server.

### Step 9:

Server records the change request or reservation operation information in association with existing data.

Server accepts, as input, the change request message or reservation operation message from the terminal. Server parses the message to extract the request identifier, schedule entry identifiers, and the content of the change or reservation instruction. Server writes the extracted information into corresponding database tables, storing change requests in a change history table and reservations in a reservation table, each linked to the request identifier and the relevant schedule entries through identification fields. Server may perform consistency checks, such as verifying that requested reservations correspond to existing schedule entries and that requested changes do not violate basic constraints (for example, overlapping times). The output of this step is an updated database state in which original condition information, prompt sentences, structured schedule information, and user feedback data are explicitly associated via identifiers.

### Step 10:

Server generates a revised prompt sentence based on the change request and obtains an updated travel schedule.

Server retrieves, as input, the stored condition information, the prior structured schedule information, and the recorded change request associated with the same request identifier. Server synthesizes these inputs into a revised prompt sentence by combining the original conditions, a summary of the previous plan, and explicit modification instructions derived from the change request. Server uses template rules to insert these elements into a natural language structure, for example:

“Original conditions:

Travel style: The user wants to enjoy nature.

Budget: Within 100,000 yen.

Physical strength: The user is confident in their stamina.

Prioritized points: Active experiences.

Previous plan (summary):

[Summary of the existing plan here.]

User's new request:
Reduce the total walking time per day.
Add one day focused on hot springs and relaxation.

Please revise the previous travel plan to satisfy the new request.

Output the updated daily schedule, a short explanation of how physical burden is reduced, and an updated cost estimate.”

Server stores this revised prompt sentence in the prompt history table and transmits it to the generative AI model using the same network interface and inference configuration process described earlier. Server then receives updated travel schedule text from the generative AI model. The output of this step is a new block of unstructured travel schedule text that reflects both original conditions and user-specified modifications.

### Step 11:

Server updates structured schedule information and returns updated presentation information to the terminal.

Server takes, as input, the newly generated travel schedule text and the existing structured schedule information and reservation operation information. Server parses the new schedule text to build updated structured schedule information, using the same parsing and extraction rules as in the initial generation, while optionally preserving previously confirmed reservations as fixed constraints. Server writes the updated structured entries into the database, associating them with a new version identifier. Server then generates new presentation information based on the updated structured schedule and transmits this updated presentation information to the terminal, indicating that it is an updated version of the plan. The output of this step is revised presentation information that the terminal can display to show a refined, constraint-consistent travel plan to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented travel planning systems generally rely on predefined rule sets, fixed templates, or static recommendation engines that operate on limited user profile attributes. As a result, such systems are unable to flexibly generate travel plans that reflect complex, context-dependent user requirements, such as combinations of budget constraints, physical ability, preferred activity level, family composition, and subjective emphasis factors. When users attempt to refine or correct automatically generated plans, conventional systems often require the entire planning process to be repeated, or require manual editing by the user, leading to increased latency, inconsistent results, and a high cognitive burden on the user.

Further, existing integrations of generative AI models into travel planning workflows commonly treat the AI model as a simple text generator that receives free-form prompts and returns unstructured text. Such approaches do not adequately leverage structured representations of user constraints or travel plan components. The absence of systematic structuring and restructuring of input and output information results in poor controllability of the generated plans, difficulty in enforcing budgetary or schedule constraints, and inefficient use of computing resources due to repeated full-plan generation instead of targeted partial updates.

In addition, in many existing systems, user feedback is handled as ad hoc textual comments that are not formally integrated into the underlying data model. Consequently, feedback cannot be effectively translated into machine-interpretable constraints, and iterative refinement of plans requires significant human intervention or re-prompting, which introduces redundant data processing and network traffic. From a computer technology standpoint, this leads to suboptimal usage of processing resources, non-deterministic behavior in the interaction with the generative AI model, and limited scalability of the system when serving many concurrent users.

Therefore, there is a need for an improved computer-implemented system and method that: (i) acquires and structures detailed condition information from users; (ii) systematically converts such structured condition information into prompt sentences for a generative AI model; (iii) converts the model's unstructured output into structured travel plan data with explicit fields; and (iv) iteratively updates both prompt sentences and structured travel plan data based on user feedback. Such a system should improve the efficiency, controllability, and reliability of travel plan generation and refinement by optimizing how the processor, memory, storage, and communication interfaces cooperate with a generative AI model.

The specific processing by the specific processing unit 290 of the data processing device 12 in Example 2 is realized by the following means.

The present invention provides a server comprising a processor and a memory storing instructions which, when executed by the processor, cause the processor to acquire condition information from a user via a terminal device through an input screen, analyze the acquired condition information to generate structured information including at least budget conditions, preference conditions, age conditions, physical ability conditions, and other attribute information, access a storage device storing travel-related information and, based on the structured information and the travel-related information, generate a prompt sentence for a generative AI model, input the prompt sentence into the generative AI model to cause the generative AI model to generate travel plan information, convert travel plan information output by the generative AI model into structured travel plan data including at least accommodation information, food and beverage information, sightseeing information, activity information, time allocation information, and cost estimation information, store the structured travel plan data in the storage device and transmit the structured travel plan data to the terminal device, receive evaluation information or modification request information relating to the travel plan data from the terminal device, update the prompt sentence on the basis of the evaluation information or the modification request information and the structured information, and re-input the updated prompt sentence into the generative AI model to regenerate the travel plan information and update the structured travel plan data accordingly. This enables a computer-centered improvement in travel planning by systematically structuring user constraints and plan components, tightly coupling prompt generation and model output structuring in an iterative loop, reducing redundant computation and network traffic, and increasing the accuracy, controllability, and responsiveness of a generative-AI-based travel plan generation system.

The term “system” refers to an arrangement of one or more computing devices, including at least one processor and at least one memory, configured to execute instructions to perform the travel plan generation and refinement operations described herein.

The term “processor” refers to one or more hardware processing units, such as a central processing unit or a graphics processing unit, capable of executing computer-readable instructions to perform arithmetic operations, logical operations, control operations, and data processing operations.

The term “memory” refers to one or more hardware storage media, such as volatile memory or non-volatile memory, configured to store computer-readable instructions and data for access and execution by the processor.

The term “storage device” refers to a hardware data storage component, such as a magnetic disk, solid-state drive, or other non-volatile storage medium, configured to store travel-related information, condition information, and structured travel plan information.

The term “terminal device” refers to a user-operable computing apparatus, such as a mobile communication device, a portable information processing device, or a stationary information processing device, that includes at least a display unit and an input unit and is capable of communicating with the server over a communication network.

The term “display unit” refers to a hardware component, such as a liquid crystal display, an organic light-emitting display, or another visual output interface, configured to present graphical or textual user interface elements to a user.

The term “input screen” refers to a graphical user interface presented on the display unit that includes one or more input fields, selection controls, or interactive components for acquiring condition information from a user.

The term “communication network” refers to a wired or wireless data communication infrastructure, such as a local area network, a wide area network, or a public data network, that enables data exchange between the server and the terminal device.

The term “condition information” refers to user-specific input data acquired from the terminal device, including at least budget conditions, preference conditions, age conditions, physical ability conditions, and other attributes relevant to generation of a travel plan.

The term “budget conditions” refers to one or more numerical or categorical values indicating monetary limitations or ranges specified by a user for costs associated with a travel plan.

The term “preference conditions” refers to one or more descriptors or categories representing a user's interests, likes, or priorities, including, for example, desired types of activities, preferred environments, or food preferences.

The term “age conditions” refers to information indicating one or more age-related attributes of a user or a group of users, such as age ranges or age categories, used to tailor the travel plan.

The term “physical ability conditions” refers to information representing a user's physical capacity or activity level, including, for example, walking endurance, tolerance for strenuous activities, or mobility limitations.

The term “other attribute information” refers to additional user-related or trip-related parameters, distinct from budget conditions, preference conditions, age conditions, and physical ability conditions, that may influence generation of a travel plan.

The term “structured information” refers to condition information or travel plan information that has been organized into a predefined data format, such as key-value pairs, lists, or relational records, suitable for systematic processing by the processor.

The term “travel-related information” refers to data stored in the storage device relating to travel resources, including at least information about lodging facilities, food and beverage facilities, sightseeing locations, and activities.

The term “prompt sentence” refers to character information in a natural language or semi-structured format that encodes instructions, constraints, and context, and that is intended for input to a generative AI model to cause generation or modification of travel plan information.

The term “generative AI model” refers to a machine learning-based information processing model configured to perform natural language processing, including generation of text content in response to input prompt sentences, by using trained parameters and computational operations.

The term “travel plan information” refers to content generated by the generative AI model that describes a proposed travel schedule, including at least recommended facilities, locations, activities, and associated times and costs.

The term “accommodation information” refers to a subset of travel plan information or travel-related information describing lodging facilities, including at least facility identifiers, locations, stay durations, and estimated costs.

The term “food and beverage information” refers to a subset of travel plan information or travel-related information describing eating and drinking facilities, including at least facility identifiers, types of cuisine or offerings, and estimated costs.

The term “sightseeing information” refers to a subset of travel plan information or travel-related information describing locations of interest to visitors, including at least place identifiers, descriptions, and recommended visiting times.

The term “activity information” refers to a subset of travel plan information or travel-related information describing experiential or participatory events, such as tours, sports, or cultural activities, including at least activity descriptions, locations, and estimated durations.

The term “time allocation information” refers to data specifying start times, end times, durations, or sequencing of elements within a travel plan.

The term “cost estimation information” refers to data indicating expected monetary amounts associated with elements of a travel plan, including at least approximate prices, fees, or total cost summaries.

The term “structured travel plan data” refers to travel plan information that has been converted into a structured format, such as a data record or a nested data structure, containing explicit fields for accommodation information, food and beverage information, sightseeing information, activity information, time allocation information, and cost estimation information.

The term “evaluation information” refers to data received from the terminal device indicating a user's assessment of a generated travel plan, including approval, dissatisfaction, or qualitative comments.

The term “modification request information” refers to data received from the terminal device specifying user-intended changes to at least a part of a generated travel plan, such as replacing facilities, altering schedules, or adjusting budgets.

The term “update the prompt sentence” refers to a processing operation in which the processor modifies an existing prompt sentence by incorporating evaluation information, modification request information, or updated structured information to generate a revised prompt sentence for re-input to the generative AI model.

The term “regenerate the travel plan information” refers to a processing operation in which the generative AI model generates new or revised travel plan information in response to an updated prompt sentence.

The term “data structuring processing” refers to a set of operations performed by the processor to convert raw character information and selection information acquired from the input screen into structured information in accordance with a predefined data schema.

The term “character information” refers to textual data, including letters, numbers, and symbols, input by the user via the input screen.

The term “selection information” refers to non-textual input data acquired from the input screen, including, for example, selected items from lists, toggles, checkboxes, or other graphical user interface controls.

The term “facility candidates” refers to one or more potential facilities, such as lodging facilities or food and beverage facilities, proposed or considered for inclusion in the travel plan.

The term “activity candidates” refers to one or more potential activities, such as tours or events, proposed or considered for inclusion in the travel plan.

The term “schedule configuration” refers to the arrangement of travel plan elements over time, including ordering, grouping by day, and assignment of time allocation information.

The term “cost constraints” refers to one or more limitations or ranges imposed on monetary amounts associated with the travel plan, derived at least from the budget conditions.

In one embodiment, a server includes at least one processor, a main memory, a non-volatile storage device, a network interface, and executes an operating system and one or more application programs that implement the functions described in the claims. The server communicates with at least one terminal operated by a user over a communication network. The terminal includes at least a processor, a display unit, an input unit, a local memory, and a communication interface, and executes an operating system and a web browser or a dedicated application program.

The server executes a web application or an application programming interface implemented, for example, using a server-side runtime environment and a server-side framework. The server stores travel-related information, condition information, and structured travel plan data in a database management system such as a relational database or a document-oriented database. The generative AI model is provided either as an external service accessible through an application programming interface or as a locally deployed model executed on a computing node equipped with a graphics processing unit.

The terminal displays an input screen generated by the server, for example an HTML-based form rendered in a web browser or a native user interface rendered by a dedicated application.

The user operates the terminal to input condition information, such as budget, preferred styles of travel, age range, and physical ability, into text fields, selection lists, sliders, or other graphical controls. The terminal converts these inputs into a structured request and transmits the request to the server via the communication interface.

The server receives the condition information and stores it in the storage device as records. The server converts the received condition information into structured information according to a predefined data schema. For example, the server maps free-form text describing budget into a normalized numerical range, maps age into a categorical value, and encodes physical ability into one of several discrete levels. The server also accesses travel-related information stored in the database, such as records describing lodging facilities, food and beverage facilities, sightseeing locations, and activities, each record including attributes such as location coordinates, opening hours, typical cost, popularity scores, and tags representing categories.

The server generates a prompt sentence for a generative AI model by combining the structured information representing user conditions with selected travel-related information. In one embodiment, the server uses a prompt construction module implemented as a software component that concatenates templates and variable fields. The server explicitly encodes constraints such as maximum total cost, maximum daily walking distance, preferred activity categories, and required time windows into the prompt sentence.

For example, the server may generate an initial prompt sentence such as:

“User profile: Budget 50,000 JPY in total. Interests: active travel and local food. Age group: 2s. Physical strength: high. Destination: Osaka. Duration: 2 days and 1 night. Please act as a professional travel planner and generate a detailed day-by-day travel plan including specific lodging facilities, restaurants, sightseeing spots, and activities. For each item, specify approximate start time, end time, and cost. Keep the total estimated cost within 50,000 JPY.”

In another example, the server may generate a more constrained prompt sentence such as:

“The user wants a 3-day family trip to Kyoto with two adults and one child (8 years old). Total budget: 80,000 JPY. Interests: temples, gardens, and light walking. Avoid long hikes and steep stairs. Please propose a travel plan that includes specific lodging facilities, kid-friendly restaurants, and sightseeing spots with short walking distances. Include time schedules and estimated costs, and ensure the total cost does not exceed 80,000 JPY.”

The server inputs the prompt sentence into a generative AI model. In one embodiment, the generative AI model is a transformer-based neural network. The model includes a plurality of layers, each layer having a multi-head self-attention mechanism and feed-forward sublayers. The model has been trained on text corpora including travel-related descriptions and structured itinerary examples. The model parameters include weight matrices and bias vectors learned through gradient-based optimization.

During training, a training system minimizes a loss function such as cross-entropy between predicted tokens and ground-truth tokens, using a stochastic gradient descent algorithm or a variant such as Adam. The training system updates the weights of the multi-head attention modules and feed-forward networks by backpropagating gradients computed from batches of training sequences. The training data includes augmented samples in which structured travel data is converted into descriptive text, as well as samples in which text prompts are paired with partially structured outputs. Data augmentation techniques such as random masking, paraphrasing, and schedule permutation are used to improve robustness.

At inference time, the server sends the prompt sentence to the generative AI model. The model encodes the prompt sentence into token embeddings, processes the embeddings through multiple attention layers, and decodes output tokens using a decoding strategy such as beam search or sampling with temperature control. The model outputs a sequence of tokens that represent a natural language description of a travel plan. In one variation, the server constrains the output format by including explicit instructions in the prompt to generate lists, headings, or delimiters that are easy to parse.

The server receives the output text and applies a parsing module implemented as a software component. The parsing module converts the natural language description into structured travel plan data. For instance, the server identifies day boundaries, time expressions, facility names, and approximate costs using pattern matching, lexical analysis, and rule-based extraction. The server maps extracted facility names and locations to records in the travel-related database by calculating similarity scores between text tokens and stored facility attributes. The server then creates structured records representing each travel element, including fields such as day index, start time, end time, facility identifier, activity category, and cost estimate.

The server stores the structured travel plan data in the database. The server also computes summary statistics, such as total estimated cost, total walking time, and time distribution per category, by aggregating over the structured records. By maintaining the travel plan in a normalized, structured form, the server can perform efficient queries and updates at the level of individual elements, rather than regenerating the entire plan for each modification.

The terminal receives the structured travel plan data from the server and renders it on the display unit. The user reviews the plan and may provide evaluation information or modification request information. For instance, the user may input feedback such as:

“I want to change the dinner restaurant on Day 1 to a cheaper local place and avoid spicy food.”

The terminal sends this feedback to the server. The server stores the feedback and associates it with the corresponding travel plan records. The server analyzes the feedback and updates the structured information by identifying which elements are targeted for modification (for example, specific restaurant entries on Day 1). The server then constructs an updated prompt sentence that includes a representation of the current plan and the requested constraints.

For example, the server may generate a revision-oriented prompt sentence such as:

“Current plan for Day 1 in Osaka: [Day 1 schedule: Hotel A check-in at 15:00, sightseeing at Location X from 16:00 to 18:00, dinner at Restaurant B at 19:00 with estimated cost 4,000 JPY per person]. User feedback: ‘Change the dinner restaurant on Day 1 to a cheaper local place and avoid spicy food.’ Please propose one or two alternative restaurants that satisfy the new constraints. Keep the rest of the Day 1 schedule unchanged. Output the updated dinner information with restaurant name, type of cuisine, approximate cost, and time.”

The server sends this updated prompt to the generative AI model. In this case, the server ensures that the prompt encodes the existing structured data and explicitly instructs the model to modify only a subset of the plan. The server may also specify that the output must follow a semi-structured pattern, for example by indicating labeled sections such as “Updated Dinner Option 1:” and “Updated Dinner Option 2:”.

The generative AI model processes the revision prompt, taking into account the existing schedule and the new constraints. Because the model has been trained on examples involving partial modifications and constraint satisfaction, the internal attention mechanisms assign higher weights to tokens describing the Day 1 dinner and the feedback constraints, while preserving context about the rest of the plan. This selective modification behavior differs from a simple regeneration of an entire itinerary and reduces unnecessary computation.

The server merges the updated elements produced by the generative AI model into the existing structured travel plan data. The server replaces only the records corresponding to the modified dinner restaurant, recomputes the total cost, and validates that the new plan still satisfies global constraints such as total budget and daily time windows. If necessary, the server applies additional rule-based checks, such as ensuring that the new restaurant is geographically reachable within the allotted time slot. The server then stores the revised structured travel plan data as a new version in the database and sends the updated plan to the terminal.

This arrangement produces several technical effects. Because the server uses structured representations of user conditions and travel plan elements, the server can generate prompt sentences that are more precise and less ambiguous than free-form text, leading to more stable and predictable behavior of the generative AI model. The server reduces the amount of data sent to and received from the generative AI model by encoding only relevant portions of the plan in the revision prompts, which decreases communication overhead and inference time. By performing partial updates on structured travel plan data, the server avoids recomputation of unchanged portions of the plan, thereby improving processing efficiency and reducing load on computing resources.

From a computer technology perspective, the system improves the internal operation of the server by introducing a specialized data schema and algorithm for integrating generative AI outputs with structured records. The server employs non-conventional processing: instead of treating AI outputs as static text, the server uses a feedback loop in which prompt construction and structured parsing are jointly optimized. The server builds prompt sentences that explicitly reference internal identifiers, normalized cost values, and categorical labels, and the generative AI model is configured, through training and prompt design, to produce outputs that can be deterministically mapped back to such structures. This design reduces parsing errors and improves the accuracy of cost calculations and schedule integrity.

The generative AI model itself is configured with architectural and training choices adapted to the travel planning context. For example, the model uses positional encodings aligned with time-of-day tokens to better capture temporal sequences, and uses additional special tokens for budget levels and activity categories. During training, the model is exposed to synthetic samples where budgets and time windows are deliberately stressed near constraints, and the loss function incorporates penalty terms for violating budget or time constraints in the generated text. This yields a parameterization in which the model tends to generate plans that satisfy numerical constraints more accurately than a generic language model.

In one alternative embodiment, the server hosts the generative AI model locally on a hardware accelerator device, such as a graphics processing unit, and performs inference within the same data center. This reduces latency and allows the server to adjust decoding parameters dynamically based on system load. The server may adaptively choose between higher-precision decoding and faster, lower-precision decoding depending on user interaction patterns. This dynamic control results in better utilization of hardware resources and improved responsiveness compared to systems that send static prompts to an external service without such control.

In another embodiment, the server maintains multiple prompt construction strategies and selects one based on current system metrics. For example, when the server detects high traffic or limited AI inference capacity, the server simplifies prompts to request only incremental changes rather than full plan descriptions. This reduces the number of tokens processed by the generative AI model and can be reflected in a reduced inference time. Thus, the system does not merely automate human planning but actively manages computational workloads and network usage at the machine level.

The system also differs from conventional rule-based engines by combining rule-based validation with neural generation in a coordinated manner. The server applies deterministic rules after generation to detect inconsistencies such as overlapping time slots or budget overruns, and, if detected, automatically constructs corrective prompts that describe the specific inconsistency and instruct the model to repair it. This closed-loop correction mechanism leads to lower error rates in final plans and provides a technical improvement in the reliability of AI-generated structured content.

In yet another embodiment, the server supports multiple types of terminal. A stationary terminal such as a desktop device presents the travel plan with rich visualization, including maps and timelines, while a portable terminal such as a mobile communication device presents a simplified version suitable for smaller screens. The server adapts the granularity of structured plan data transmitted to each terminal type, reducing the amount of data transmitted to portable terminals to save bandwidth and power consumption. This adaptive data transmission further improves communication efficiency.

Because the server always stores and processes condition information and travel plan data in structured form, and because the server controls how prompt sentences and model outputs interact with that structure, the system achieves improvements in processing speed, accuracy of constraint satisfaction, and resource usage. These improvements arise from specific technical features: a defined data schema, a prompt construction algorithm that encodes internal structure, a parsing algorithm that recovers structure from model outputs, and a feedback mechanism that localizes modifications. The system therefore constitutes a technical solution that enhances computer technology itself rather than a mere automation of human travel planning tasks.

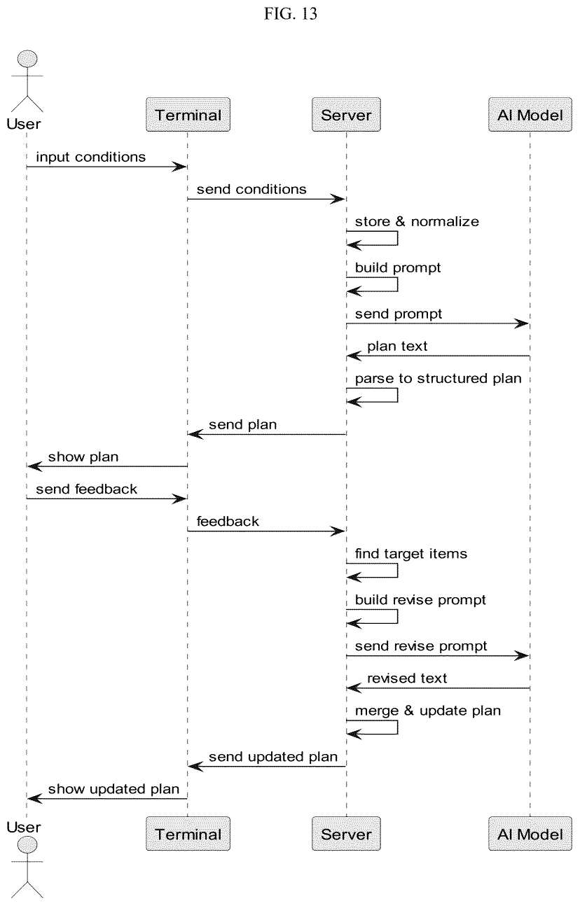

The following describes the processing flow using FIG. 13.

### Step 1:

The terminal displays an input screen and acquires condition information from the user.

The terminal presents input fields, selection lists, and buttons on the display unit, and the user operates the terminal to input text values such as desired destination, budget, number of days, age group, and physical ability, and to select options such as preferred activities and food types.

The input of this step is user interaction events and raw text/selection values. The terminal converts these events into internal variables, performs basic validation (for example, checks that budget fields contain numeric characters and that required fields are not empty), and outputs a structured request object that contains condition information to be sent to the server.

### Step 2:

The terminal transmits the structured condition information to the server.

The terminal packages the structured request object into a message including headers and a body, encodes the condition information as a serialized data structure, and sends the message through the communication interface over a network.

The input of this step is the structured request object created in Step 1. The terminal performs data formatting and network transmission processing, such that the output is a network message arriving at the server that contains the user's condition information.

### Step 3:

The server receives the condition information and stores it in a storage device.

The server accepts the network message through a network interface, parses the serialized data structure, and extracts fields such as budget, age group, physical ability, preferred activity categories, and travel dates.

The input of this step is the message containing structured condition information from the terminal. The server maps these fields into internal data records according to a predefined schema, executes data type conversion and normalization (for example, converts currency strings to numeric values and normalizes date formats), and writes the normalized records into one or more tables in a database. The output is condition information stored as persistent records associated with a user identifier or request identifier.

### Step 4:

The server converts the condition information into structured information for prompt construction.

The server reads the stored condition records from the database, groups related fields, and constructs a structured representation including budget conditions, preference conditions, age conditions, physical ability conditions, and other attribute information.

The input of this step is normalized database records created in Step 3. The server applies data aggregation, tagging, and categorization algorithms, for example mapping free-text interests into predefined category labels using keyword lookup or similarity scoring. The output is a structured information object that organizes all relevant user constraints in a machine-processable format for subsequent processing.

### Step 5:

The server acquires travel-related information corresponding to the structured user conditions.

The server queries the database containing travel-related records for lodging facilities, food and beverage facilities, sightseeing locations, and activities that match or approximate the conditions specified in the structured information object.

The input of this step is the structured information object from Step 4. The server executes query operations with filter conditions (for example, price range, location region, and category tags), performs joins and ranking operations based on cost, distance, and popularity, and outputs a set of candidate travel-related records that are potentially suitable for the user.

### Step 6:

The server constructs a prompt sentence for a generative AI model based on the structured user conditions and candidate travel-related information.

The server calls a prompt construction module, which applies a template and inserts values representing budget constraints, preferred categories, duration, and examples of candidate facilities.

The input of this step is the structured information object from Step 4 and the set of candidate records from Step 5. The server performs string concatenation, token normalization, and ordering of conditions to form a coherent natural language instruction. For example, the server may generate a prompt sentence such as:

“User profile: Budget 50,000 JPY in total. Interests: active travel and local food. Age group: 20s. Physical strength: high. Destination: Osaka. Duration: 2 days and 1 night. Please generate a detailed day-by-day travel plan including specific lodging facilities, restaurants, sightseeing spots, and activities. For each item, specify approximate start time, end time, and cost. Keep the total estimated cost within 50,000 JPY.”

The output is a completed prompt sentence in text form, ready for input to the generative AI model.

### Step 7:

The server inputs the prompt sentence into the generative AI model and obtains travel plan text.

The server transmits the prompt sentence to the generative AI model via an inference interface, where the model encodes the sentence into tokens, propagates them through multiple neural network layers, and decodes a sequence of output tokens representing a travel plan description.

The input of this step is the textual prompt sentence created in Step 6. The server initiates a remote or local procedure call to the model, manages parameters such as maximum output length and decoding method, and waits for the model to complete the forward pass and token generation. The output is a natural language text describing a travel plan, which the server receives as a contiguous string.

### Step 8:

The server parses the generated travel plan text and converts it into structured travel plan data.

The server applies a parsing module that analyzes the text to identify days, time slots, facility names, activity descriptions, and cost expressions. The server uses pattern matching rules, token-based segmentation, and mapping to existing facility records.

The input of this step is the travel plan text returned from the generative AI model in Step 7. The server breaks the text into segments by day markers, scans for temporal expressions (for example, “9:00-11:00”), detects cost phrases (for example, “about 3,000 JPY per person[), and compares extracted names with stored facility names using similarity calculations. The output is structured travel plan data, including for each plan element fields for day index, start time, end time, facility identifier or free-text name, activity type, and estimated cost.

### Step 9:

The server validates and stores the structured travel plan data in the storage device.

The server checks the structured travel plan data for constraint violations, such as total cost exceeding the budget by more than a threshold, overlapping time intervals, or gaps that exceed allowable idle times.

The input of this step is the structured travel plan data from Step 8. The server executes numerical comparisons, temporal conflict detection, and rule evaluation. If inconsistencies are detected, the server may annotate the data or initiate additional corrective processing. Once validated, the server writes the structured records into the travel plan tables in the database, associating them with the user or request identifier. The output is a stored and validated travel plan that can be retrieved and displayed by the terminal.

### Step 10:

The server transmits the structured travel plan data to the terminal, and the terminal displays the plan to the user.

The server retrieves the necessary fields from the stored travel plan data and formats them into a response structure suitable for presentation. The terminal receives the response, interprets the structure, and renders visual elements such as daily schedules, facility names, and cost summaries on the display unit.

The input of this step at the server side is the stored structured travel plan data from Step 9. The server performs data selection, serialization, and network transmission, and the output is a network message containing the structured travel plan. The input of this step at the terminal side is the received message; the terminal converts the payload into display items, orders them by day and time, and outputs a graphical interface through the display unit that the user can review.

### Step 11:

The user evaluates the displayed travel plan and inputs evaluation information or modification request information through the terminal.

The user inspects the plan, identifies undesired elements (for example, a specific restaurant, an activity time, or a total cost level), and uses text fields or controls to express preferences, such as “start later in the morning” or “replace the dinner restaurant with a cheaper local option.”

The input of this step is the visual representation of the travel plan shown on the terminal in Step 10. The user cognitively evaluates this representation and provides input through the input unit.

The terminal converts this user feedback into a structured feedback object, containing references to affected plan elements and textual description of requested changes. The output is structured evaluation information or modification request information prepared for transmission.

### Step 12:

The terminal transmits the evaluation information or modification request information to the server.

The terminal encapsulates the structured feedback object into a message, adds necessary identifiers such as the plan identifier and user identifier, and sends the message through the communication interface to the server.

The input of this step is the structured feedback object produced in Step 11. The terminal performs serialization and network communication processing, and the output is a feedback message received by the server.

### Step 13:

The server analyzes the feedback and identifies target portions of the structured travel plan data for modification.

The server reads the feedback message, extracts references to plan elements such as specific days or activities, and retrieves the corresponding records from the database.

The input of this step is the feedback message transmitted in Step 12 and the existing structured travel plan stored from Step 9. The server matches references in the feedback (for example, “Day 1 dinner restaurant”) to internal records using identifiers or search criteria, and compiles a subset of the plan that is subject to change. The output is a modification context object that contains the targeted structured plan elements and the constraint description provided by the user.

### Step 14:

The server constructs an updated prompt sentence for the generative AI model that encodes both the current plan context and the user's requested changes.

The server uses the modification context object and structured condition information to build a revision prompt. The server inserts a summary of the relevant portion of the existing plan and appends explicit textual instructions describing the modification.

The input of this step is the modification context object from Step 13 and the previously stored structured condition information. The server performs string assembly operations, incorporates numeric values such as existing costs and time slots, and generates a natural language instruction. For example, the server may produce an updated prompt sentence such as:

“Here is the current Day 1 plan in Osaka: Check-in at Hotel A at 15:00, sightseeing at Location X from 16:00 to 18:00, dinner at Restaurant B at 19:00 with estimated cost 4,000 JPY per person. The user feedback is: ‘Change the dinner restaurant on Day 1 to a cheaper local place and avoid spicy food.’ Please propose one or two alternative dinner restaurants that satisfy these constraints. Keep the check-in time and sightseeing schedule unchanged. Output the updated dinner information with restaurant name, type of cuisine, approximate cost, and time.”

The output is an updated prompt sentence prepared for re-input to the generative AI model.

### Step 15:

The server inputs the updated prompt sentence into the generative AI model and obtains revised travel plan elements.

The server sends the updated prompt sentence to the generative AI model and requests generation of only the modified components, such as alternative dinner restaurants and associated costs.

The input of this step is the revision prompt sentence from Step 14. The server passes the prompt to the model, controls inference parameters, and receives output describing one or more revised plan elements. The output is a textual description of updated elements, for example a list of alternative restaurants with attributes, returned from the generative AI model.

### Step 16:

The server merges the revised elements into the existing structured travel plan data and updates stored records.

The server parses the textual description of revised elements, extracts restaurant names, cost values, and time information, and maps them to new or existing facility records.

The input of this step is the textual revision output from Step 15 and the existing structured travel plan from Step 9. The server converts the new textual information into structured records, replaces the fields of the targeted plan elements, recalculates total cost and checks constraint satisfaction, and writes updated records to the database as a new version of the plan. The output is an updated structured travel plan that incorporates the user-requested modifications while preserving unchanged parts of the plan.

### Step 17:

The server transmits the updated structured travel plan data to the terminal, and the terminal updates the displayed plan.

The server retrieves the revised plan records, structures them into a response, and sends the response to the terminal. The terminal receives the response, identifies which elements have changed, and refreshes the display accordingly.

The input of this step at the server side is the updated structured travel plan created in Step 16.

The server performs serialization and network transmission, and the output is a message containing the updated plan. The input of this step at the terminal side is the updated plan message; the terminal updates only the modified items, such as the dinner section for Day 1, and outputs an updated visual representation to the display unit so that the user can confirm the changes.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented travel planning and dining planning systems mainly act as static search and aggregation engines. Such systems typically require a user to manually input many parameters, browse large lists of options, and iteratively refine results by trial and error. The underlying computation is often limited to simple filtering and rule-based ranking over pre-defined databases. As a result, these systems have several technical drawbacks from the perspective of computer technology.

First, conventional systems do not exploit generative AI models in a structured, feedback-driven loop. Even where a generative AI model is invoked, the interaction is usually a one-shot text generation based directly on raw user input. The system does not normalize heterogeneous user data (free-form text, numerical constraints, context, and affective signals) into a unified internal representation, does not systematically construct machine-oriented prompt sentences from that representation, and does not parse and reintegrate the model's output into machine-readable itinerary structures. This ad-hoc use of generative AI leads to unstable output quality and requires significant human intervention, thereby limiting the throughput and reliability of the computing system.

Second, conventional systems lack a technical mechanism to integrate real-time emotional information and behavioral context (such as VR/AR exploration behavior or implicit preferences) into the computational loop. Emotion recognition, if used at all, is commonly treated as an external analytics function, not tightly coupled with the planning engine. There is no coherent architecture for acquiring multi-modal user data on a terminal, performing emotion analysis on a server, storing affective states as part of structured user attribute data, and systematically feeding this information into a prompt-construction pipeline for a generative AI model. As a consequence, the computing system cannot automatically adapt its planning algorithms to the user's changing state, resulting in suboptimal recommendations and frequent manual corrections.

Third, known systems do not provide an integrated pipeline from generative planning to machine-actuated reservation execution. Typically, any auto-generated plan remains a loose text description. It is not automatically mapped to structured itinerary entries, enriched with facility identifiers and availability data obtained from external reservation interfaces, nor updated bidirectionally when booking succeeds or fails. This separation of planning and execution forces users to bridge the information gap themselves, increasing latency, interaction complexity, and the number of network transactions required to complete reservations.

Fourth, conventional architectures do not define a reusable, machine-friendly representation of itinerary information that supports iterative refinement. Where a generative AI model is used, its free-form text output is not consistently converted back into structured internal data that can be efficiently searched, summarized, and selectively modified by the server. Without this structured feedback channel, the system cannot programmatically generate refinement prompt sentences that preserve suitable parts of an itinerary while changing specific parameters such as activity intensity, break times, or cost allocation. This reduces the ability of the computing system to converge quickly toward high-quality plans using minimal computation and network resources.

Accordingly, there is a need for an improved computer-implemented system that (i) normalizes heterogeneous user input and affective signals into abstracted user attribute data, (ii) programmatically generates prompt sentences for a generative AI model based on such structured data, (iii) parses the model's output into structured itinerary information that can be repeatedly refined, and (iv) tightly integrates external reservation interfaces so that generated plans can be automatically executed and updated. Such a system should improve the efficiency, determinism, and adaptability of the planning process as a whole, thereby constituting a concrete improvement in the functioning of the underlying computer system, rather than merely automating a human mental process.

The specific processing by the specific processing unit 290 of the data processing device 12 in Application Example 2 is realized by the following means.

The present invention provides a server comprising a processor configured to acquire, from a user terminal, input information related to travel conditions or dining conditions, analyze the input information to normalize the input information into abstracted user attribute data including at least a budget, a schedule, an activity intensity, a preference, and an emotional state, generate structured internal data related to a travel schedule or a dining plan based on the user attribute data and on at least one of position information from the user terminal and behavior history in a virtual environment, convert the structured internal data into a machine-generated prompt sentence in natural language as an instruction sentence to be input to a generative AI model, input the prompt sentence to the generative AI model, receive travel schedule information or dining plan information output from the generative AI model, parse and structure the output information into itinerary information including day-based and time-zone-based action items, cost estimates, and physical load indices, convert the itinerary information into at least one of a travel guide document format and a meal plan document format for presentation, transmit the document format to the user terminal, receive, from the user terminal, feedback information including at least one of a change request and satisfaction information with respect to the presented itinerary information, regenerate a further prompt sentence based on the feedback information and the structured itinerary information, re-input the further prompt sentence to the generative AI model to update the itinerary information” communicate, via an external reservation communication interface associated with at least one of an accommodation facility, a dining facility, a transportation means, and an activity included in the updated itinerary information, to transmit reservation requests and receive reservation responses, associate reservation results with corresponding action items in the itinerary information, and perform emotion analysis processing on at least one of image information, audio information, and text information acquired from the user terminal to estimate the emotional state of a user and update the user attribute data and subsequent prompt sentences in accordance with the estimated emotional state. This enables the computing system to implement a closed-loop, machine-controlled planning pipeline in which heterogeneous user inputs and emotional signals are unified into structured attributes, prompt sentences for the generative AI model are automatically constructed and refined, generated plans are converted into structured itineraries suitable for algorithmic modification, and external reservation operations are executed and reflected back into the itinerary, thereby improving the technical performance, adaptability, and automation capability of the underlying computer-based planning and reservation architecture.

The term “user terminal” refers to an information processing device operated by a user, such as a general-purpose computing device or wearable device, that provides an interface for inputting information and displays information received from a server.

The term “input information” refers to data provided from the user terminal to the server, including at least travel conditions, dining conditions, budget constraints, schedule constraints, user preferences, and other parameters used for planning.

The term “travel conditions” refers to constraints and requirements related to a travel context, including at least destination, dates, duration, budget, desired activities, activity intensity, and accommodation preferences.

The term “dining conditions” refers to constraints and requirements related to a meal context, including at least cuisine preferences, dietary restrictions, budget, time, and location for dining.

The term “user attribute data” refers to normalized and abstracted information representing characteristics of a user, including at least budget, schedule, activity intensity, preferences, behavioral patterns, and emotional state, which is used as an internal representation for computation.

The term “abstracted user attribute data” refers to user attribute data that has been transformed from raw heterogeneous inputs into a higher-level, standardized internal format suitable for algorithmic processing and prompt generation.

The term “budget” refers to a numerical constraint indicating a monetary amount that the user is willing or able to spend for travel or dining.

The term “schedule” refers to temporal constraints of a plan, including at least dates, times, duration of stay, and temporal allocation of activities.

The term “activity intensity” refers to an indication of a level of physical or mental load associated with planned actions, such as walking distance, number of activities per day, or overall exertion level.

The term “preference” refers to a user's favored or disfavored categories, attributes, or patterns related to travel or dining, such as preferred activity types, locations, cuisines, or ambience.

The term “emotional state” refers to a classification of the user's psychological and affective condition, such as joy, satisfaction, stress, fatigue, or dissatisfaction, estimated by emotion analysis.

The term “position information” refers to data indicating a geographical location of the user terminal or another relevant object, expressed for example as coordinates or location identifiers.

The term “behavior history in a virtual environment” refers to records of a user's actions and interactions within a virtual or augmented environment, including at least gaze duration, selected points of interest, movement paths, and interaction events.

The term “structured internal data” refers to machine-readable data representing a travel schedule or dining plan in a structured format, such as records or objects, that can be programmatically processed, searched, and transformed.

The term “travel schedule” refers to an arrangement of travel-related activities over one or more time periods, including at least visit locations, activity contents, timing, and associated resources.

The term “dining plan” refers to an arrangement of meal-related activities over one or more time periods, including at least selected dining facilities, menu categories, timing, and budget allocation.

The term “prompt sentence” refers to a natural language instruction sentence or set of sentences generated by the server to be input to the generative AI model, specifying conditions, constraints, and required output format.

The term “generative AI model” refers to an information processing model configured to generate new content, such as text or structured data, in response to an input prompt sentence, by performing statistical or machine-learning-based computation.

The term “output information” refers to content generated and returned by the generative AI model in response to the prompt sentence, including at least travel schedule information or dining plan information.

The term “travel schedule information” refers to generated content that describes a proposed travel itinerary, including day-by-day and time-zone-based actions, locations, and related attributes.

The term “dining plan information” refers to generated content that describes a proposed meal schedule or meal arrangement, including times, locations, and types of meals.

The term “itinerary information” refers to structured information obtained by parsing and organizing the output information, including at least action items, timing, cost estimates, and physical load indices.

The term “action item” refers to a unit element of an itinerary, representing a specific activity or operation, such as visiting a location, traveling between locations, dining, or resting, associated with a time period.

The term “day-based” refers to a granularity of itinerary information that is segmented by calendar days or equivalent time units.

The term “time-zone-based” refers to a granularity of itinerary information that is segmented by intra-day time ranges, such as morning, afternoon, evening, or specific time intervals.

The term “cost estimates” refers to approximate monetary amounts associated with one or more action items or portions of the itinerary.

The term “physical load indices” refers to numerical or categorical indicators representing expected physical effort or exertion required by one or more action items.

The term “travel guide document format” refers to a representation of itinerary information in a human-readable document style suitable for presenting a travel plan, such as a structured text, markup, or visual layout.

The term “meal plan document format” refers to a representation of itinerary information specific to dining arrangements in a human-readable document style.

The term “feedback information” refers to information received from the user terminal indicating a user reaction to the presented itinerary information, including at least change requests, ratings, or satisfaction indications.

The term “change request” refers to an instruction from a user to modify one or more parts of the current itinerary, such as adding, removing, or altering activities, times, costs, or intensity.

The term “satisfaction information” refers to data representing a user's approval, disapproval, or degree of acceptance of one or more itinerary elements.

The term “updated itinerary information” refers to itinerary information that has been modified based on a further prompt sentence, user feedback, or reservation results.

The term “external reservation communication interface” refers to a software and network interface used by the server to transmit reservation-related messages to and from external reservation services.

The term “accommodation facility” refers to a location that provides lodging services, such as a general lodging service provider.

The term “dining facility” refers to a location that provides prepared food or beverages for consumption, such as a general food service provider.

The term “transportation means” refers to a conveyance or service enabling movement between locations, such as a vehicle, public transit service, or other travel service.

The term “activity” refers to an event, service, or experience that a user participates in during a travel or dining plan, excluding basic transit and lodging, such as sightseeing, tours, or entertainment.

The term “reservation request” refers to a message transmitted from the server to an external reservation service to request a booking for a facility, service, or activity included in the itinerary information.

The term “reservation response” refers to a message received by the server from an external reservation service indicating success, failure, or conditions of a reservation request.

The term “reservation result” refers to information representing the outcome of a reservation process, including at least confirmation data, identifiers, and status information.

The term “image information” refers to digital visual data acquired from the user terminal, including still images or video frames suitable for analysis of user facial expressions or context.

The term “audio information” refers to digital sound data acquired from the user terminal, including spoken utterances and other audio signals.

The term “text information” refers to alphanumeric data representing user input or generated content in textual form.

The term “emotion analysis processing” refers to computational processing applied to at least one of image information, audio information, and text information to estimate a user's emotional state.

The term “plan summary information” refers to a condensed representation of structured itinerary information and any change request, expressed in a form suitable for inclusion in a further prompt sentence.

The term “regeneration prompt sentence” refers to a prompt sentence generated by the server for refining or correcting an existing itinerary, including plan summary information, user attribute data, and emotional state as conditions.

The term “facility identification information” refers to identifiers that uniquely or sufficiently specify a facility or service, such as a lodging, dining, or activity provider, in an external service.

The term “position coordinate information” refers to location data expressed in coordinates or equivalent format that identify the physical position of a facility or activity site.

The term “availability information” refers to data indicating whether a facility, service, or activity is available for reservation at specified times and conditions.

The term “reservation identifier” refers to an identifier assigned by an external reservation service or the server to a confirmed or provisional reservation.

The term “cancellation condition” refers to rules and constraints governing cancellation of a reservation, including time limits, fees, and penalties.

The term “final itinerary information” refers to itinerary information that has been augmented with reservation identifiers, cancellation conditions, and any other confirmation details, suitable for execution of the plan.

In one embodiment, a server implements the claimed system as a network-connected computing apparatus including at least one processor, a main memory, a non-volatile storage, a communication interface, and one or more machine-readable storage media storing executable programs. The server executes the programs to realize functional modules for input acquisition, data normalization, prompt sentence generation, generative AI model interaction, itinerary structuring, emotion analysis, reservation control, and response generation. A terminal implements a user interface device, such as a smart phone, a tablet, a wearable display device, or a general-purpose computer, configured to capture multi-modal user data and to present itinerary information. A user operates the terminal to input travel and dining conditions and to review and adjust generated plans.

The server executes a web application backend using a general-purpose application framework such as a scripting runtime with an HTTP server framework and a data analysis environment such as a general-purpose high-level language with scientific libraries. The server stores user attribute data, structured internal data, itinerary information, and reservation results in a database system such as a document-oriented database. The terminal executes a client application implemented for example as a native mobile application or a browser-based single-page application.

The server acquires input information from the terminal via a communication protocol such as HTTPS. The terminal allows the user to enter travel conditions and dining conditions, including a budget, dates, desired destinations, activity intensity preferences, and dining preferences, through graphical user interface components such as forms, sliders, and option selectors. The terminal additionally allows the user to enter free-form text describing preferences or constraints, which the terminal sends to the server as textual data.

The server normalizes heterogeneous input information into abstracted user attribute data by executing specific data processing operations. The server converts date strings into an internal date-time representation, converts currency values into a base currency unit, and maps qualitative descriptors such as “very active” or “not much walking” into numerical or categorical activity intensity levels. The server aggregates user preferences from repeated usage into profile vectors that represent long-term tendencies toward categories such as nature, culture, shopping, or nightlife. The server stores these abstracted user attribute data structures in the database, indexed by user identifiers.

The server maintains structured internal data formats for travel schedules and dining plans. In one example, the server represents a travel schedule as a list of day objects, each day object including time slots, location identifiers, activity types, estimated costs, and physical load indices. The server represents a dining plan as a list of meal entries including time of day, cuisine category, cost range, and contextual constraints such as proximity to a location in the travel schedule. These data structures are defined so that each field can be programmatically accessed, compared, and modified without parsing free-form text.

The server generates a prompt sentence for a generative AI model by applying a prompt construction algorithm to the abstracted user attribute data and the structured internal data. The server executes a prompt-builder module that receives normalized fields such as total budget, number of days, destination, and long-term preferences, and assembles a natural-language instruction according to a template. The prompt-builder selects different templates according to whether the task is initial plan generation, plan refinement, or dining-only planning. The prompt-builder inserts explicit instructions for output formatting, such as requiring the model to output data in a pseudo-structured textual form that can be reliably parsed.

In one embodiment, the server generates a prompt sentence such as:

“The user's budget is 50,000 yen for 3 days in Kyoto and prefers an active schedule. Please generate a detailed day-by-day travel plan with morning, afternoon, and evening segments, including recommended sightseeing spots, restaurants, and accommodations within the budget.

The user likes temples and local food and wants to avoid nightlife. Return the result as a list of days, each with time ranges, place names, activity descriptions, and approximate costs.”

In another embodiment, the server generates a refinement prompt sentence such as:

“Here is the current 3-day Kyoto plan: Day 1: central temples with long walking segments; Day 2: mountain hiking and river area; Day 3: shopping streets. The user wants fewer walking-intensive activities in the afternoon and prefers more nature spots. Please revise the plan while keeping the total budget at 50,000 yen and the same dates. Keep activities that match temples and nature, and replace long shopping walks with short visits and rest breaks.”

For dining-focused planning, the server may generate a prompt sentence such as:

“Based on the following order history (frequent pizza orders, occasional salads, low spicy tolerance), please propose a meal plan for tonight that the user is likely to enjoy, limited to 2,500 yen and delivered by 7 p.m. Include the type of meal, cuisine category, and recommended price range.”

The server interacts with a generative AI model that is implemented, for example, as a transformer-based neural network. The generative AI model consists of an embedding layer that maps tokens into continuous vectors, multiple self-attention layers that compute contextualized representations, feed-forward layers, and an output layer that predicts the probability distribution over tokens for each position. The model is trained before deployment on a large corpus of itinerary descriptions, travel guides, restaurant reviews, and scheduling examples, such that it learns to map constrained prompt sentences into coherent multi-day plans. The training process uses a loss function such as cross-entropy between predicted tokens and ground-truth tokens, and the model updates its weights using a gradient-based optimization method such as stochastic gradient descent or an adaptive variant. During training, the system performs data augmentation by rephrasing constraints and by adding synthetic variations of budgets and intensities to increase robustness.

The server configures the generative AI model at inference time with parameters such as a temperature, a maximum output length, and penalties for repetition. By explicitly guiding the model with structured prompt sentences that contain abstracted user attribute data and desired output formats, the server improves determinism and reduces the need for manual interpretation of the model's output. This structured prompt-design and parsing loop is a technical mechanism that improves the reliability and efficiency of using a large generative AI model for itinerary generation.

The server receives output information from the generative AI model as text. The server executes a parsing algorithm that transforms this text into itinerary information compatible with the internal structured format. In one embodiment, the server instructs the model to produce a line-based or delimited representation, such that each line corresponds to a specific action item with a recognizable pattern (for example, “Day 1, Morning, Kiyomizu Temple, Sightseeing, 2 hours, 2,000 yen”). The server applies a line parser that splits each line on delimiters, validates the expected number of fields, and converts textual values into structured fields. The server computes physical load indices by mapping activity types and durations to pre-defined intensity scores and then aggregating those scores per day and per segment.

The server associates parsed locations with external data sources by matching place names to identifiers in a separate facility database or via external location services. The server calls a mapping service interface to obtain coordinates and possibly category tags for each recommended place, storing these in the itinerary information. Because the itinerary information is stored as structured internal data, the server can perform efficient queries, such as retrieving all high-intensity afternoon segments or all dining actions within a certain budget range, without re-parsing free-form text.

The terminal displays itinerary information in document-like formats. The server converts structured itinerary information into travel guide document formats by generating human-readable sections such as “Day 1-Morning,” including bullet points for each action item with time ranges, locations, and short descriptions. For dining plans, the server creates meal plan document formats listing recommended meals, approximate prices, and times. The terminal renders this information as scrollable views or cards, and the user can open details, such as maps and reservation status indicators.

The user provides feedback information by interacting with the terminal. The user may deselect certain activities, adjust budget sliders, add comments such as “too much walking in the afternoon,” or rate specific items positively or negatively. The terminal consolidates this feedback information into structured messages indicating targeted changes (for example, “reduce daily walking hours below a threshold” or “add more local cuisine restaurants”) and transmits these messages to the server.

The server uses the feedback information and the existing itinerary information to generate new prompt sentences without discarding the entire plan. The server computes a plan summary information item by summarizing key properties of the current itinerary, such as the distribution of activity intensities, the main types of activities per day, and total costs. The server then embeds this plan summary, along with abstracted user attribute data and current emotional state information, into a regeneration prompt sentence. By specifying which parts of the existing itinerary should be kept and which aspects should be changed, the server reduces the search space for the generative AI model and improves convergence to a satisfactory plan with fewer iterations.

The server acquires emotional state information from multi-modal data captured by the terminal.

The terminal, with user consent and under privacy controls, captures image information from a camera and audio information from a microphone while the user views proposed itineraries or interacts with the planning interface. The terminal may perform initial compression or subsampling to reduce bandwidth and sends the data to the server along with context identifiers indicating which screen or itinerary element the user was viewing.

The server executes emotion analysis processing implemented through one or more recognition modules. In one embodiment, the server uses an image-processing library to detect faces and extract facial expression features such as mouth curvature, eye openness, and eyebrow shape.

The server maps these features to emotion scores using a classifier that has been trained on labeled facial expressions. For audio information, the server transcribes spoken comments into text using a speech recognition interface and applies a sentiment analysis model to the text to compute positive or negative sentiment scores. In some embodiments, the server also uses specialized emotion-recognition interfaces that output categorical labels such as “joy,” “stress,” or “fatigue” together with confidence scores.

The server integrates emotional state estimates into the user attribute data and into the prompt sentences. For example, if the server detects repeated negative emotions associated with hiking activities and positive emotions for cultural visits and local dining, the server adjusts user attribute vectors to lower the weight of high-intensity outdoor activities and increase the weight of cultural and dining activities. The server then generates prompt sentences that explicitly describe these affective preferences. An example of such a prompt sentence is:

“The user showed positive emotions when viewing temple visits and local restaurants, and negative emotions when viewing long hiking routes. Please propose a new 3-day travel plan in Kyoto that emphasizes temples and local eateries and minimizes long hikes, while keeping the budget and dates unchanged.”

By feeding emotion-informed attributes into the generative AI model through structured prompt sentences, the server enables the computer system to automatically adapt plans based on non-verbal and indirect signals that are not easily or consistently provided through manual user input.

This adaptation is implemented through specific data structures and algorithms, not by simply replacing human judgment with automation.

The server performs reservation operations by interfacing with external reservation communication interfaces for accommodation facilities, dining facilities, transportation means, and activities. The server iterates over action items in the updated itinerary information and identifies those that require reservations. For each such item, the server selects a corresponding facility or service by matching facility identification information and desired time ranges. The server sends reservation requests to external reservation services via network APIs, including necessary parameters such as dates, times, number of persons, and price constraints. The server receives reservation responses indicating success, failure, or alternative suggestions.

The server records reservation identifiers, availability information, and cancellation conditions in the itinerary information, associating these data with specific action items. The server updates the itinerary to reflect confirmed times and capacities and marks unavailable actions as needing revision. Because the itinerary information is structured, the server can re-run selection and matching procedures for only affected segments rather than regenerating the entire plan. The terminal displays the reservation status and provides the user with confirmation details and options to cancel or reschedule, which the server again handles through the reservation communication interfaces.

The described architecture yields technical improvements in several respects. The use of abstracted user attribute data and structured internal itinerary data reduces the amount of redundant parsing and interpretation operations that would otherwise be necessary each time the generative AI model is queried. The server avoids repeatedly processing unstructured text by maintaining a canonical machine-readable representation of constraints and plans, which leads to reduced computational cost and faster response times.

The prompt construction and parsing loop is designed to limit the variability of model outputs and thereby reduce errors in downstream processing. By specifying explicit output formats and by summarizing current plans and constraints into compact prompt sentences, the server reduces the variance of model responses, which yields more stable behavior and reduces the number of correction cycles that must be executed. This corresponds to a concrete improvement of the computer system's overall computation efficiency and predictability when integrating a generative AI model.

The combination of emotion analysis and itinerary adjustment improves accuracy with respect to user satisfaction without requiring more manual specification of preferences. Because the server encodes emotion-derived preferences into structured data and subsequently into prompt sentences, the system can identify patterns across sessions and reuse them programmatically.

This data-driven adaptation is different from manual rule-based personalization, and it allows the server to discover correlations between activity types and emotion signals that would not be feasible to maintain by static rules alone. The structured integration of emotion signals thus increases the fidelity of the planning engine and reduces the need for manual editing of itineraries.

The reservation integration also improves technical performance. Rather than having the user manually re-enter plan details into multiple reservation services, the server automatically translates structured itinerary elements into reservation requests. The server also feeds back success or failure of reservations into the itinerary information and can re-run limited segments of the planning process when necessary. This reduces the number of network interactions and the amount of duplicated work for both the server and the user terminal. Because reservations and itinerary segments are linked at the data-structure level, the system maintains consistency and reduces errors such as double-bookings or mismatched times.

In alternative embodiments, the server can use different generative AI models, as long as such models accept a prompt sentence as input and produce planning-related text or structured output.

For example, the server can interact with a locally hosted sequence-to-sequence model trained specifically on domain data, or can apply a hybrid architecture where a smaller domain-specific model refines or filters results from a larger general-purpose model. The server can also vary the internal representation of structured data, for example, by using relational tables instead of document structures, or by extending the set of fields to include environmental conditions such as weather forecasts or accessibility constraints.

In further embodiments, the terminal can operate as an augmented reality device, where the user views points of interest in a mixed-reality interface. The terminal transmits user gaze direction and selection events to the server, and the server incorporates these behavioral signals into user attribute data. The server then constructs prompt sentences that take into account observed interest in physical locations rather than only declared preferences, thereby adapting the generated itineraries to the user's real-world exploration patterns.

By combining specific data structures for user attribute data and itinerary information, explicit prompt construction and parsing algorithms, transformer-based generative AI models trained with defined loss functions and optimization procedures, emotion analysis pipelines, and reservation control mechanisms, the system implements more than a generic automation of human planning. The server re-organizes and coordinates computational resources such that itinerary and dining plans are generated, refined, and executed with improved speed, accuracy, and robustness. This constitutes a concrete improvement in the functioning of the computer system as a planning and reservation engine.

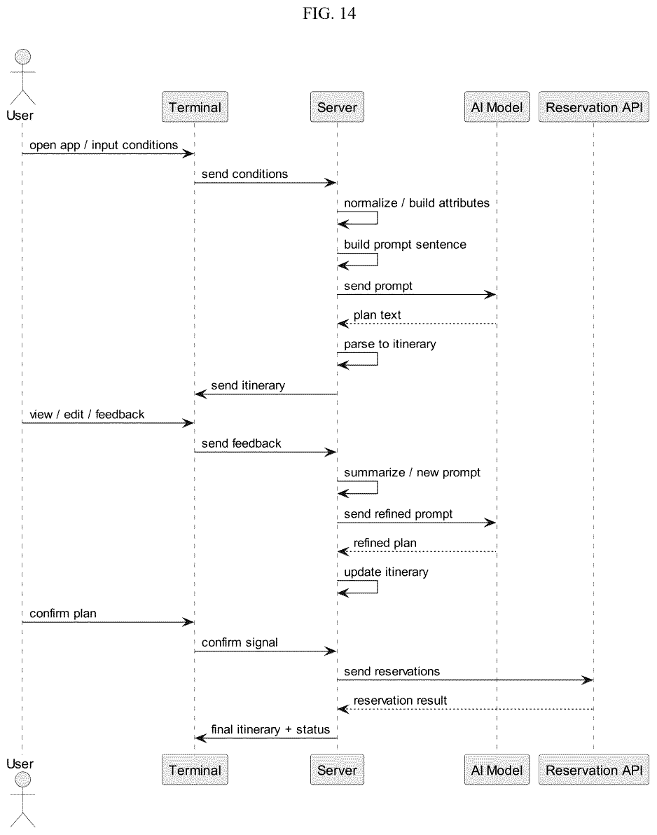

The following describes the processing flow using FIG. 14.

### Step 1:

User operates the terminal to input planning conditions.

User launches a planning application on the terminal and enters travel conditions and/or dining conditions, such as destination, dates, total budget, preferred activity intensity, preferred activity types, and dining preferences, via graphical input components. User may also input free-form text, such as “Please propose a 3-day active trip to Kyoto within 50,000 yen.” The input of this step is raw user-entered values and text on the terminal. The output of this step is structured form data and text strings held in the terminal's memory.

### Step 2:

Terminal transmits input information to the server.

Terminal validates the input fields (for example, checks date formats and numeric ranges) and packages them into a request payload, such as a JSON object containing keys for budget, dates, destination, and free-form comments. Terminal sends this payload to the server via a secure communication protocol. The input of this step is the structured form data and text strings from Step 1. The output of this step is a network message containing user input information delivered to the server.

### Step 3:

Server normalizes user input into abstracted user attribute data.

Server receives the network message and parses the payload to extract raw values. Server converts date strings into an internal date-time representation, converts currency amounts into a base unit, maps qualitative text such as “very active” into a numerical activity intensity code, and merges current input with historical profile data from a database. Server computes derived values, such as budget per day and target number of activities per day, by performing arithmetic operations on the extracted fields. The input of this step is the raw user input information. The output of this step is abstracted user attribute data stored as structured records in server memory and in a database.

### Step 4:

Server generates structured internal planning data.

Server uses the abstracted user attribute data to create an initial internal representation of a travel schedule or dining plan, without yet filling specific locations. Server allocates days based on dates, divides each day into time slots (for example, morning, afternoon, evening), and assigns initial capacity values such as maximum walking hours or meal counts per day. Server performs data operations such as creating arrays of day objects, initializing fields for each time slot, and tagging slots with permissible activity categories based on preferences and intensity. The input of this step is the abstracted user attribute data from Step 3. The output of this step is structured internal data representing an empty or partially constrained itinerary framework.

### Step 5:

Server constructs a prompt sentence for the generative AI model.

Server executes a prompt-builder routine that reads the abstracted user attribute data and the structured internal data. Server selects a template corresponding to the current operation type (for example, initial generation or refinement) and substitutes placeholder tokens with actual values, such as “50,000 yen,” “3 days,” and “Kyoto.” Server concatenates constraint descriptions, preference summaries, and formatting instructions into a single natural language text. Server may include a section describing the desired output structure, such as requesting a line-per-action format. The input of this step is the structured internal data and user attribute data. The output of this step is a complete prompt sentence string ready for submission to the generative AI model.

### Step 6:

Server sends the prompt sentence to the generative AI model and receives output information.

Server forwards the prompt sentence to a generative AI model interface, specifying inference parameters such as maximum tokens and sampling temperature. The generative AI model tokenizes the prompt sentence, encodes the tokens into vector representations, propagates them through multiple attention layers and feed-forward layers, and decodes a sequence of output tokens according to learned probability distributions. Server receives the resulting text string, which describes a proposed travel schedule or dining plan. The input of this step is the prompt sentence from Step 5. The output of this step is raw output information produced by the generative AI model in textual form.

### Step 7:

Server parses the output information into structured itinerary information.

Server applies a parsing algorithm to the generative AI model's text. Server splits the text into lines or segments, identifies markers such as “Day 1” or “Morning,” and extracts fields like time ranges, location names, activity descriptions, and approximate costs. Server converts extracted numeric substrings into numerical values and assigns categorical codes to activity types. Server also computes physical load indices by mapping activity types and durations to pre-defined intensity scores and aggregating them per time slot and per day. The input of this step is the raw output text from Step 6. The output of this step is structured itinerary information, where each action item is represented as a record with fields for time, place, activity type, cost, and load index.

### Step 8:

Server enriches itinerary information with external facility and location identifiers.

Server consults a facility database or external location service using place names extracted from the itinerary information. Server performs string matching or search queries to resolve textual place names into facility identification information and position coordinate information. Server attaches the obtained identifiers, coordinates, and category tags to corresponding action items in the itinerary information. The input of this step is structured itinerary information from Step 7 and external facility data. The output of this step is enriched itinerary information containing both human-readable descriptions and machine-usable identifiers.

### Step 9:

Server converts itinerary information into document formats and sends them to the terminal.

Server generates one or more document-oriented representations of the itinerary, such as a structured JSON layout for UI components or a textual travel guide style summary. Server groups action items by day and time segment, adds headings and descriptive text, and marks slots that will require reservations. Server organizes the data into a response message and transmits it to the terminal over the network. The input of this step is the enriched itinerary information from Step 8. The output of this step is a formatted itinerary payload delivered to the terminal.

### Step 10:

Terminal displays the itinerary and collects user feedback.

Terminal receives the formatted itinerary payload and parses it into internal view models.

Terminal renders day-by-day views and item cards displaying time ranges, locations, activities, and costs. User scrolls through the presented information and interacts with controls such as buttons and sliders to indicate likes, dislikes, or specific change requests (for example, “reduce walking in the afternoon” or “add more local food restaurants”). Terminal records these interactions along with references to the affected action items. The input of this step is the formatted itinerary payload from Step 9 and user actions. The output of this step is feedback information and potential change requests stored on the terminal.

### Step 11:

Terminal sends feedback information to the server.

Terminal aggregates user feedback into a structured message that includes identifiers of targeted action items, types of requested modifications, and optional user comments. Terminal may also include updated numeric constraints, such as a lower activity intensity or a reallocated budget.

Terminal transmits this feedback payload to the server using the same secure communication channel. The input of this step is the feedback information from Step 10. The output of this step is a feedback message delivered to the server.

### Step 12:

Server summarizes the current plan and generates a regeneration prompt sentence.

Server receives the feedback message and retrieves the latest itinerary information from its database. Server computes summary statistics such as total cost, average activity intensity per day, and counts of certain activity types. Server creates a plan summary text describing the key characteristics of each day, then integrates this summary with the explicit change requests into a regeneration prompt sentence. Server updates user attribute data if necessary (for example, lowering preferred intensity) and embeds these updates into the prompt. The input of this step is the feedback message and the stored itinerary information. The output of this step is a regeneration prompt sentence targeted at refining the existing plan.

### Step 13:

Server refines the itinerary using the generative AI model.

Server sends the regeneration prompt sentence to the generative AI model and receives a revised output text that proposes changes to the plan while preserving specified elements. Server repeats the parsing and structuring operations analogous to Steps 7 and 8, translating the revised text into updated structured itinerary information. Server then stores the updated itinerary and prepares new document formats. The input of this step is the regeneration prompt sentence from Step 12. The output of this step is an updated itinerary information set and newly formatted itineraries available for redisplay.

### Step 14:

Terminal captures emotion-related data while the user views itineraries.

Terminal, with user permission, activates sensors such as a camera and microphone while the itinerary is displayed. Terminal captures image information of the user's face and audio information of spoken comments. Terminal may also capture rudimentary physiological or behavioral signals if available, such as head movements. Terminal associates timestamps and screen context with each capture and optionally compresses or subsamples the data. The input of this step is live sensor data as the user interacts with the itinerary. The output of this step is emotion-related sensor data and context metadata prepared for upload.

### Step 15:

Terminal sends emotion-related data to the server.

Terminal packages the captured images, audio segments, and associated context labels (for example, which day or activity was currently highlighted) into a structured message. Terminal transmits this message securely to the server, possibly batching several samples to reduce communication overhead. The input of this step is the emotion-related data from Step 14. The output of this step is an emotion data payload delivered to the server.

### Step 16:

Server performs emotion analysis and updates user attribute data.

Server receives the emotion data payload and processes image information to detect facial regions and extract expression features. Server processes audio information to generate transcripts and acoustic features. Server applies pre-trained emotion classification models to these features to estimate emotional states such as joy, stress, or fatigue, and associates these labels and scores with corresponding itinerary elements and timestamps. Server aggregates these emotion estimates over multiple samples to update the user's emotional preference profile, adjusting weights for activity categories that consistently generate positive or negative reactions.

The input of this step is the emotion-related data from Step 15. The output of this step is updated emotional state information and modified user attribute data.

### Step 17:

Server incorporates emotional state into subsequent prompt sentences and itineraries.

Server uses the updated user attribute data, including emotional preferences, when constructing future prompt sentences. Server adds explicit conditions to the prompts, such as emphasizing activity types that elicited positive emotions and reducing or modifying those linked to negative emotions. Server then generates new prompt sentences for either full regeneration or partial adjustment of plans, and processes the responses from the generative AI model as before. The input of this step is the updated user attribute data from Step 16. The output of this step is emotion-aware prompt sentences and subsequent itinerary information that better aligns with the user's inferred preferences.

### Step 18:

Server initiates reservations for action items in the updated itinerary.

Server examines the updated itinerary information to locate action items that are eligible for reservation, such as accommodations, dining, or scheduled activities. Server constructs reservation requests containing facility identifiers, time ranges, and participant counts, and sends these requests through external reservation communication interfaces. Server receives reservation responses, extracts reservation identifiers and availability outcomes, and attaches this reservation result data to the corresponding action items in the itinerary. The input of this step is the updated itinerary information from Step 13 or Step 17. The output of this step is enriched itinerary information that includes reservation identifiers, statuses, and cancellation conditions.

### Step 19:

Terminal displays reservation status and final itinerary to the user.

Terminal receives the enriched itinerary information from the server and renders indicators such as “reserved,” “pending,” or “unavailable” next to each relevant action item. User reviews the final itinerary with confirmed reservations and may choose to cancel or modify certain reservations through interface controls. Terminal records such actions and sends corresponding modification or cancellation requests back to the server for further processing through the reservation communication interfaces. The input of this step is the enriched itinerary information from Step 18 and user actions. The output of this step is a finalized, user-approved itinerary displayed on the terminal and, when appropriate, new reservation modification messages sent to the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

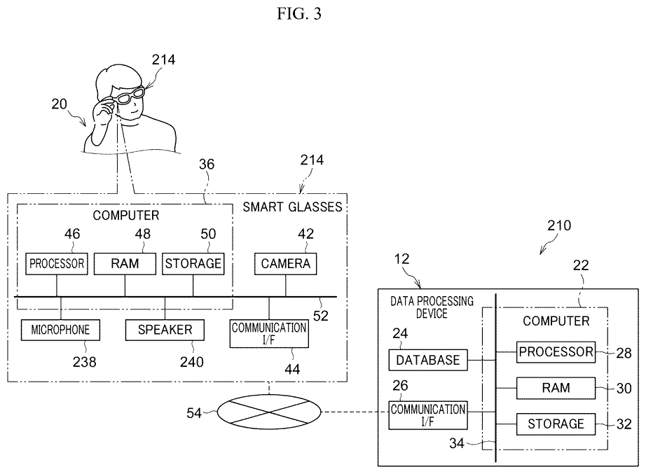

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

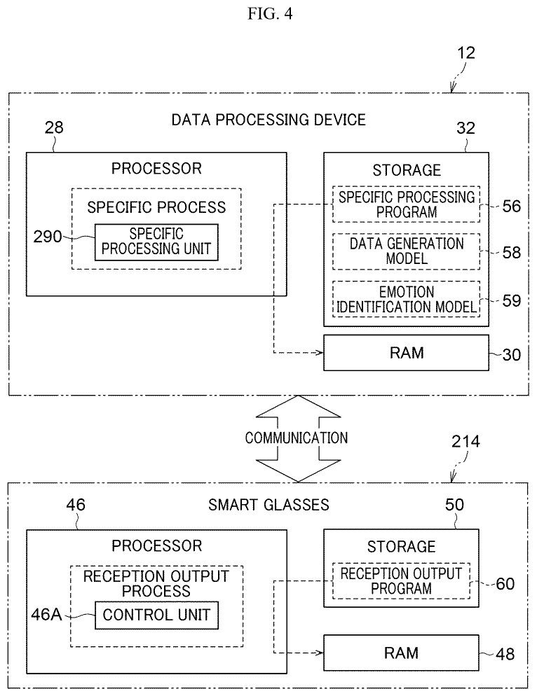

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

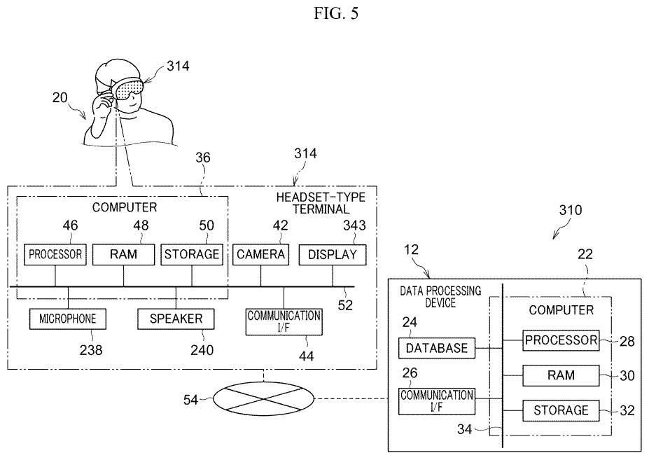

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

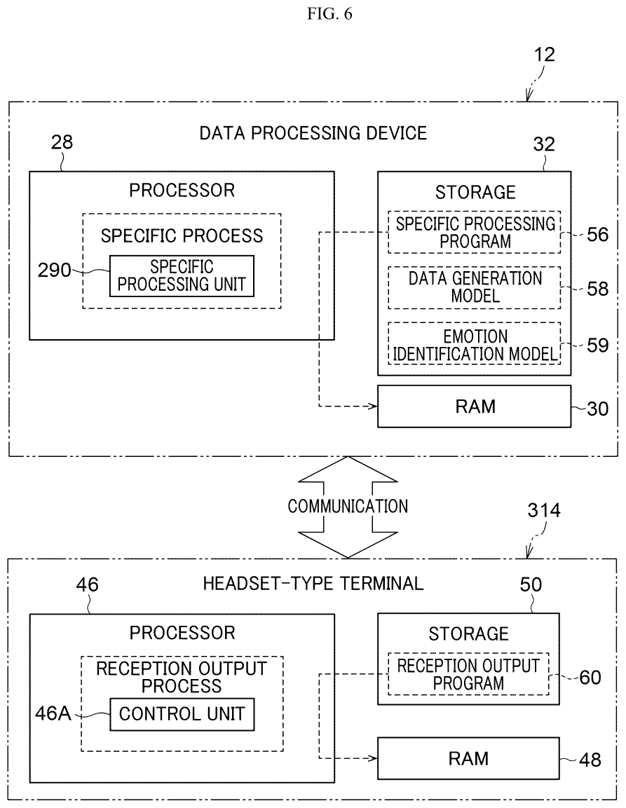

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

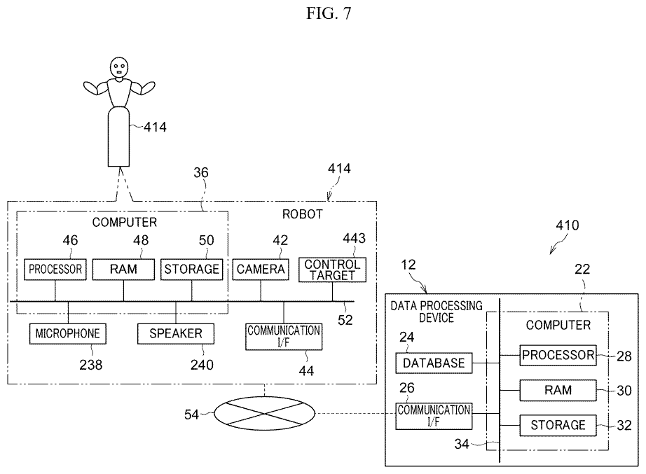

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

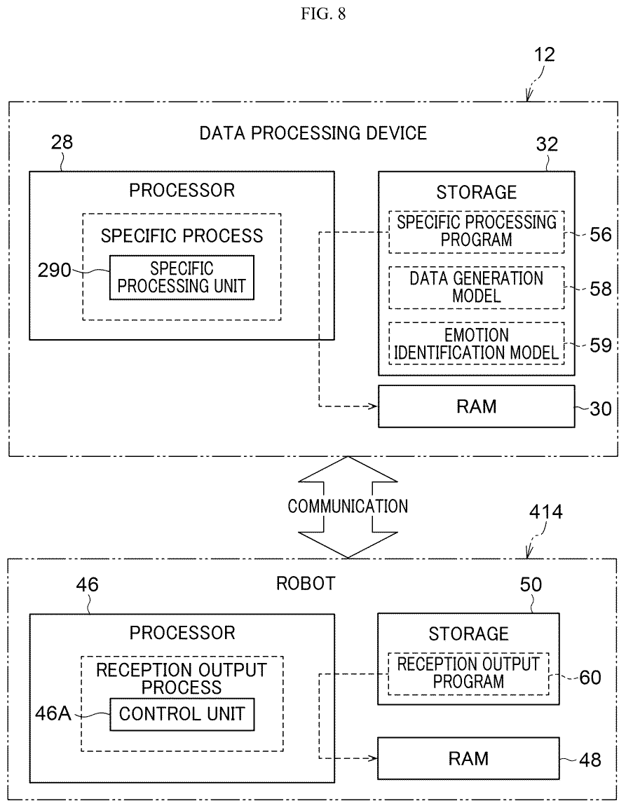

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

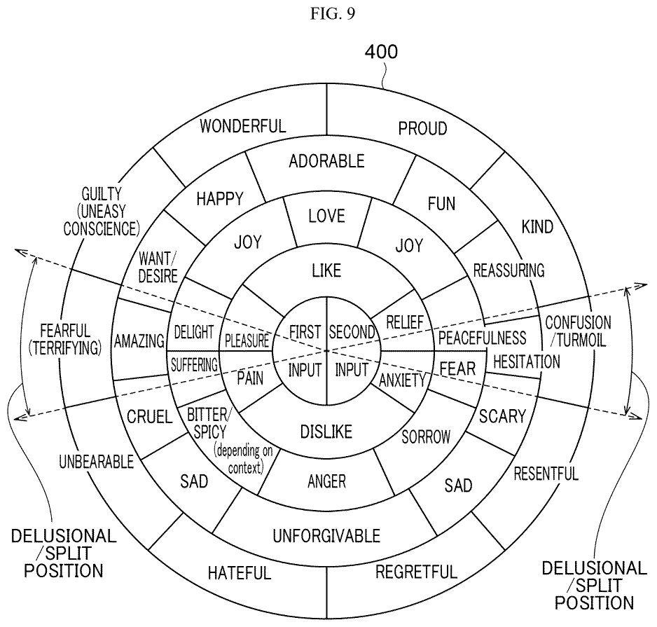

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

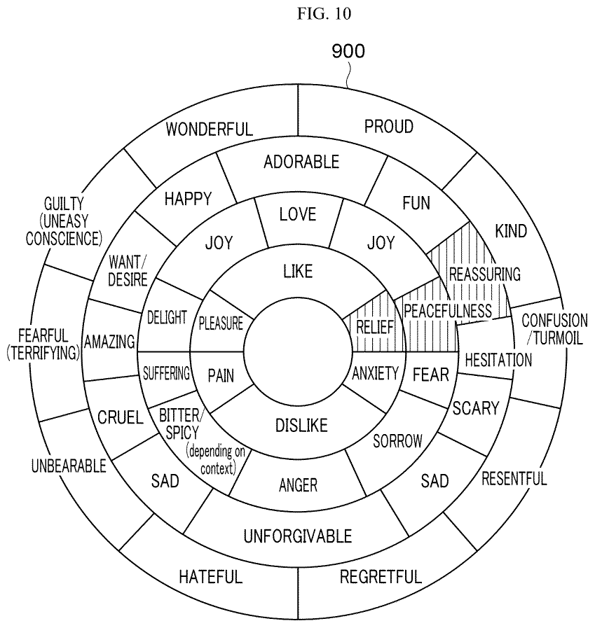

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, via a communication device, input information relating to travel conditions from a user and extract a plurality of attributes including a travel type, budget information, physical condition, priority items, travel period, and destination region from the input information, and convert the extracted attributes into standardized structured data,
generate, on the basis of the structured data, a prompt sentence that specifies an output format of a travel plan, the output format including an itinerary proposal for each travel day, activity contents for respective time zones, place names of activities, outline descriptions of the activities, and approximate costs, and conforming to at least a budget constraint and a physical condition,
transmit the generated prompt sentence, as request data, to a generative information processing model disposed internally or externally, and acquire travel plan data received from the generative information processing model,
perform a verification on the acquired travel plan data by determining whether at least a number of travel days, a division of time zones, and a total cost are within condition ranges included in the structured data, and, when inconsistency is detected, automatically generate a re-prompt sentence by adding condition emphasis information or correction condition information to the prompt sentence and re-transmit the re-prompt sentence to the generative information processing model, and
store the travel plan data that has passed the verification in a storage device in association with the structured data, convert the travel plan data into display data that is presentable on a display device as a travel plan divided by day and by time zone, and distribute the display data to a client device.

### Supplementary 2

The system according to supplementary 1,
wherein the processor is configured to
acquire additional conditions or modification requests from the user, combine the additional conditions or modification requests with travel plan data stored in the storage device, generate a revision prompt sentence that prompts a change of at least one of the budget constraint, the priority items, and the physical condition while maintaining constituent elements of an existing travel plan, and input the revision prompt sentence to the generative information processing model to acquire revised travel plan data.

### Supplementary 3

The system according to supplementary 1,
wherein the processor is configured to
convert, as the display data, travel plan data expressed in a natural language format or a structured description format into a display structure conforming to a standardized display format, and shape the display data into a format that is dynamically presentable on the client device as at least one of a scroll display, a segmented display, and a comparative display, and distribute the shaped display data to the client device.

### Application Example 1

### Supplementary 1

A system comprising a processor,
wherein the processor is configured to
acquire condition information related to travel from a user terminal,
analyze the acquired condition information to generate structured information including at least a travel style, an expenditure condition, a physical tolerance level, and an evaluation priority item,
generate, on the basis of the structured information, a prompt sentence in a natural language for instructing generation of a travel schedule proposal, and record the prompt sentence as history information,
transmit the prompt sentence to a generative AI model and obtain, from the generative AI model, a response including travel schedule information,
analyze the travel schedule information included in the response and convert the travel schedule information into structured schedule information including behavior information on a per-day basis or a per-activity basis and cost information,
convert the structured schedule information into presentation information in a format suitable for display on the user terminal, and transmit the presentation information to the user terminal,
acquire a change request or reservation operation information from a user with respect to the presentation information, and record the change request or reservation operation information in association with the condition information and the travel schedule information, and
modify the prompt sentence on the basis of the change request, and obtain updated travel schedule information by retransmitting a modified prompt sentence to the generative AI model.

### Supplementary 2

The system according to supplementary 1,
wherein the processor is configured to
generate the prompt sentence as a natural language text including at least part of the travel style, the expenditure condition, the physical tolerance level, and the evaluation priority item, and including instructions regarding a number of travel days, an output format, and a presentation method of cost breakdown, and use the natural language text as an input to the generative AI model.

### Supplementary 3

The system according to supplementary 1,
wherein the processor is configured to
store the structured schedule information and the reservation operation information in association with each other by using identification information, and include, in the prompt sentence to be provided to the generative AI model on the basis of the identification information, existing schedule summary information and change history information.

### Example 2

### Supplementary 1

A system comprising a processor and a memory,
wherein the processor is configured to
acquire condition information from a user via a terminal device through an input screen displayed by a display unit,
analyze the acquired condition information and convert the condition information into structured information including at least budget conditions, preference conditions, age conditions, physical ability conditions, and other attribute information,
access a storage device storing travel-related information and, on the basis of the structured information and the travel-related information, generate a prompt sentence as character information for instructing generation of a travel plan,
input the generated prompt sentence into a generative AI model that performs natural language processing, and cause the generative AI model to generate travel plan information corresponding to the condition information,
analyze the travel plan information acquired from the generative AI model and convert the travel plan information into structured information including at least accommodation facility information, food and beverage facility information, sightseeing location information, activity information, time allocation information, and cost estimation information,
store the structured travel plan information in the storage device and transmit the structured travel plan information to the terminal device via a communication network,
receive, from the terminal device, evaluation information or modification request information relating to the travel plan information, and update the prompt sentence on the basis of the evaluation information or the modification request information and the structured information, re-input the updated prompt sentence into the generative AI model to regenerate the travel plan information,
and update the structured information on the basis of the regenerated travel plan information and re-transmit updated travel plan information to the terminal device.

### Supplementary 2

The system according to supplementary 1,
wherein the processor is configured to
generate the prompt sentence by combining the budget conditions, the physical ability conditions, and emphasis factor conditions included in the condition information with the travel-related information obtained from the storage device so as to explicitly indicate, to the generative AI model, schedule configuration, facility candidates, activity candidates, and cost constraints.

### Supplementary 3

The system according to supplementary 1,
wherein the processor is configured to
perform data structuring processing on character information and selection information acquired through items of the input screen, and convert the character information and the selection information into the structured information used for generation of the travel plan information.

### Application Example 2

### Supplementary 1

A system comprising a processor,
wherein the processor is configured to
acquire input information related to travel conditions or dining conditions from a user terminal, and analyze the acquired input information to normalize the input information into abstracted user attribute data including a budget, a schedule, an activity intensity, a preference, and an emotional state,
and generate structured internal data related to a travel schedule or a dining plan based on the user attribute data and on at least one of position information acquired from the user terminal and a behavior history in a virtual environment, and convert the internal data into a prompt sentence in natural language as an instruction sentence to be input to a generative AI model,
and input the prompt sentence to the generative AI model, acquire travel schedule information or dining plan information output from the generative AI model, and structure the output information as itinerary information including action items on a day basis and a time-zone basis, cost estimates, and physical load indices,
and convert the structured itinerary information into at least one of a travel guide document format and a meal plan document format, and transmit the document format to the user terminal for display,
and acquire, from the user terminal, feedback information including a change request or satisfaction information with respect to the displayed itinerary information, and regenerate the prompt sentence based on the feedback information and the structured itinerary information, and re-input the regenerated prompt sentence to the generative AI model to update the itinerary information,
and, via an external reservation communication interface corresponding to at least one of an accommodation facility, a dining facility, a transportation means, and an activity included in the updated itinerary information, transmit a reservation request, acquire a reservation response, and add a reservation result to the itinerary information,
and perform emotion analysis processing on at least one of image information, audio information, and text information acquired from the user terminal to estimate the emotional state of a user, and reflect the estimated emotional state in the user attribute data and in the prompt sentence to generate or adjust the itinerary information in accordance with the emotional state.

### Supplementary 2

The system according to supplementary 1,
wherein the processor is configured to
generate a plan summary information item obtained by summarizing the structured itinerary information and the change request, and generate a regeneration prompt sentence written in natural language including the plan summary information, the user attribute data, and the emotional state as conditions, and input the regeneration prompt sentence to the generative AI model to cause the generative AI model to generate corrected itinerary information in which an existing itinerary is maintained while at least one of an activity content, a break time, and a cost allocation is changed.

### Supplementary 3

The system according to supplementary 1,
wherein the processor is configured to
associate, for each action item in the structured itinerary information, facility identification information, position coordinate information, and availability information acquired by using an external service communication means, and record a reservation identifier and a cancellation condition in the itinerary information, and transmit final itinerary information including the reservation identifier and the cancellation condition to the user terminal.

What is claimed is:

1. A system comprising:
circuitry configured to:
receive, from a client terminal via a packet-switched network, input information comprising a plurality of constraint parameters specified by a user;
extract attributes from the input information comprising a category type, resource constraint information, physical capacity information, priority items, temporal range information, and target region information, and convert the extracted attributes into standardized structured data;
generate a prompt sentence based on the standardized structured data, the prompt sentence specifying an output format for a generative neural network model, the output format comprising a sequential action plan divided by temporal segments with associated activity descriptions and estimated resource allocations;
transmit the prompt sentence to the generative neural network model via the packet-switched network and obtain plan data from the generative neural network model;
perform verification on the plan data by determining whether at least a number of temporal segments, a division of time periods, and a total resource allocation are within constraint ranges derived from the standardized structured data; and
convert the verified plan data into display data formatted for presentation on the client terminal, and transmit the display data to the client terminal via the packet-switched network.

2. The system according to claim 1, wherein the circuitry is configured to receive the input information through a form-based interface on the client terminal, parse the input information to identify each constraint parameter, validate each constraint parameter against predefined range criteria, and normalize the validated constraint parameters into the standardized structured data using a common unit system.

3. The system according to claim 2, wherein the circuitry is configured to generate the prompt sentence by mapping each attribute in the standardized structured data to a corresponding instruction segment in the prompt sentence, and to include, within the prompt sentence, explicit constraint expressions requiring the generative neural network model to satisfy the resource constraint information and the physical capacity information in the generated plan data.

4. The system according to claim 3, wherein the circuitry is configured to specify, within the prompt sentence, a structured output format requiring the generative neural network model to output the plan data as records comprising temporal segment identifiers, activity content descriptions, location identifiers, duration values, and estimated resource values for each temporal segment.

5. The system according to claim 4, wherein the circuitry is configured to parse the plan data returned by the generative neural network model according to the structured output format, validate that each record contains the required fields, and discard records that do not conform to the specified format.

6. The system according to claim 1, wherein the circuitry is configured to, when the verification detects inconsistency between the plan data and the constraint ranges, automatically generate a re-prompt sentence by appending condition emphasis information or correction condition information to the original prompt sentence, retransmit the re-prompt sentence to the generative neural network model, and obtain revised plan data.

7. The system according to claim 6, wherein the circuitry is configured to identify specific inconsistency types comprising resource allocation exceeding the resource constraint information, temporal segment count deviating from the temporal range information, and activity intensity exceeding the physical capacity information, and to generate targeted correction instructions in the re-prompt sentence for each identified inconsistency type.

8. The system according to claim 7, wherein the circuitry is configured to limit a number of re-prompt iterations to a predetermined maximum, and when the revised plan data does not satisfy the constraint ranges after the maximum iterations, to transmit the best available plan data to the client terminal together with notification data indicating which constraint parameters were not fully satisfied.

9. The system according to claim 1, wherein the circuitry is configured to receive modification request data from the client terminal, combine the modification request data with the verified plan data stored in a storage medium, generate a revision prompt sentence that adjusts at least one of the resource constraint information, the priority items, and the physical capacity information while maintaining unchanged elements of the existing plan data, and transmit the revision prompt sentence to the generative neural network model.

10. The system according to claim 9, wherein the circuitry is configured to identify, in the existing plan data, temporal segments that are affected by the modification request data and temporal segments that are unaffected, and to include in the revision prompt sentence an instruction to preserve the unaffected temporal segments while regenerating only the affected temporal segments.

11. The system according to claim 10, wherein the circuitry is configured to maintain a revision history comprising each modification request, the corresponding revision prompt sentence, and the revised plan data, and to enable the client terminal to compare plan data across revisions.

12. The system according to claim 1, wherein the circuitry is configured to convert the verified plan data into the display data by formatting the plan data into a display structure comprising a day-by-day segmented layout with activity descriptions, resource allocations, and location references for each temporal segment, and to generate the display data in a format that enables at least one of scroll display, segmented display, and comparative display on the client terminal.

13. The system according to claim 12, wherein the circuitry is configured to generate map display data by associating the location references in the plan data with geographic coordinates retrieved from a geographic information database, and to include the map display data in the display data transmitted to the client terminal.

14. The system according to claim 1, wherein the constraint parameters relate to a travel itinerary, the category type comprises a travel style, the resource constraint information comprises a travel budget, the physical capacity information comprises a physical strength level of the user, and the sequential action plan comprises a travel itinerary proposal with daily activities, place names, and approximate costs for each day of travel.

15. The system according to claim 14, wherein the circuitry is configured to acquire supplementary information comprising weather forecast data and facility availability data for the target region from external information sources via the packet-switched network, and to include the supplementary information in the prompt sentence to improve relevance of the generated travel itinerary.

16. The system according to claim 1, wherein the circuitry is configured to estimate an emotional state of the user based on linguistic features extracted from the input information, and to adjust a level of detail and a presentation style of the plan data based on the estimated emotional state.

17. The system according to claim 1, wherein the circuitry is configured to store the verified plan data and the standardized structured data in a storage medium, analyze accumulated plan data to identify patterns between constraint parameters and highly rated plan outputs, and incorporate the identified patterns as supplementary context in subsequently generated prompt sentences.

18. A system comprising:
circuitry configured to:
receive input information comprising constraint parameters from a client terminal via a packet-switched network;
convert the input information into standardized structured data;
generate a prompt sentence based on the standardized structured data specifying an output format for a generative neural network model;
transmit the prompt sentence to the generative neural network model and obtain plan data;
verify the plan data against constraint ranges derived from the standardized structured data;
when verification detects inconsistency, generate a re-prompt sentence and retransmit to the generative neural network model;
estimate an emotional state of a user and adjust a presentation of the plan data based on the emotional state; and
transmit display data formatted from the verified plan data to the client terminal via the packet-switched network.

19. The system according to claim 18, wherein the circuitry is configured to receive modification request data from the client terminal, generate a revision prompt sentence combining the modification request data with existing plan data, and obtain revised plan data from the generative neural network model.

20. A method performed by circuitry, the method comprising:
receiving input information comprising constraint parameters from a client terminal via a packet-switched network;
converting the input information into standardized structured data;
generating a prompt sentence based on the standardized structured data specifying an output format for a generative neural network model;
transmitting the prompt sentence to the generative neural network model and obtaining plan data;
verifying the plan data against constraint ranges derived from the standardized structured data;
converting the verified plan data into display data; and
transmitting the display data to the client terminal via the packet-switched network.
